(19) United States
(12) Patent Application Publication
(10) Pub. No.: US 2024/0394502 A1
(43) Pub. Date: Nov. 28, 2024

(54) SYSTEMS AND METHODS FOR A CUSTOMIZED CHATBOT USING ARTIFICIAL INTELLIGENCE

(71) Applicant: HighLevel Inc., Dallas, TX (US)

(72) Inventors: Narayana Sami, Coimbatore (IN); Puru Bansal, Bangalore (IN); Karan Agarwal, Jaipur (IN); Hardik Bhatt, Noida (IN); Dhairya Singh Raghav, Noida (IN); Himanshu Anand, Meerut (IN); Pragnesh Bhavsar, Ahmedabad (IN)

(73) Assignee: HighLevel Inc., Dallas, TX (US)

(21) Appl. No.: 18/322,978

(22) Filed: May 24, 2023

(51) Int. Cl. G06N 3/006; G06N 3/08; G06Q 10/1093; G06Q 20/22; G06Q 30/0241

(52) U.S. Cl. CPC G06N 3/006; G06N 3/08; G06Q 10/1095; G06Q 20/227; G06Q 30/0277

(57) ABSTRACT

Embodiments of a method for operating a customized chatbot using artificial intelligence is disclosed, the method comprising: receiving a message via one of a plurality of channels, each channel being communicatively coupled to one or more applications executing in one or more computing devices; identifying a meaning of the message using at least one natural language processing algorithm; retrieving information from a knowledge base, the information being relevant to the identified meaning and comprising attributes of a plurality of intents; generating, using at least one machine learning model, a response recommending an action to fulfill one in the plurality of intents, the at least one machine learning model using the information retrieved from the knowledge base to derive the recommended action; displaying the response in a user interface; and performing the recommended action.

### TECHNICAL FIELD

The present disclosure relates to systems, techniques, and methods directed to a customized chatbot using artificial intelligence.

### BACKGROUND

Artificial intelligence (AI) is a growing field in computer science that uses machine learning models to make predictions, recommendations, or classifications based on input data. Revenue from the AI software market worldwide is expected to reach 126 billion dollars by 2025 according to some estimates. In some domains, such as marketing, AI has the potential to deliver highly targeted and personalized advertisements using behavioral analysis, pattern recognition, and other learning algorithms.

### BRIEF DESCRIPTION OF DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1A is a simplified block diagram of an example system for a customized chatbot using artificial intelligence according to some embodiments of the present disclosure.

FIG. 1B is a simplified flow diagram showing example operations associated with the customized chatbot of FIG. 1A according to some embodiments of the present disclosure.

FIG. 2 is a simplified block diagram of example front-end features in the system for a customized chatbot using artificial intelligence according to some embodiments of the present disclosure.

FIGS. 3A and 3B are simplified block diagrams of example artificial intelligence features in the system for a customized chatbot using artificial intelligence according to some embodiments of the present disclosure.

FIG. 4A is a simplified block diagram of an example payment tool in the system for a customized chatbot using artificial intelligence according to some embodiments of the present disclosure.

FIG. 4B is a simplified flow diagram showing example operations associated with the example payment tool of FIG. 4A according to some embodiments of the present disclosure.

FIG. 5A is a simplified block diagram of an example marketing automation tool in the system for a customized chatbot using artificial intelligence according to some embodiments of the present disclosure.

FIG. 5B is a simplified flow diagram showing example operations associated with the example marketing automation tool of FIG. 5A according to some embodiments of the present disclosure.

FIG. 6A is a simplified block diagram of an example booking tool in the system for a customized chatbot using artificial intelligence according to some embodiments of the present disclosure.

FIG. 6B is a simplified flow diagram showing example operations associated with the example booking tool of FIG. 6A according to some embodiments of the present disclosure.

FIG. 7A is a simplified block diagram of an example support tool in the system for a customized chatbot using artificial intelligence according to some embodiments of the present disclosure.

FIG. 7B is a simplified flow diagram showing example operations associated with the example support tool of FIG. 7A according to some embodiments of the present disclosure.

FIG. 8A is a simplified block diagram of an example forms tool in the system for a customized chatbot using artificial intelligence according to some embodiments of the present disclosure.

FIG. 8B is a simplified flow diagram showing example operations associated with the example forms tool of FIG. 8A according to some embodiments of the present disclosure.

FIG. 9A is a simplified block diagram of an example reply tool in the system for a customized chatbot using artificial intelligence according to some embodiments of the present disclosure.

FIG. 9B is a simplified flow diagram showing example operations associated with the example reply tool of FIG. 9A according to some embodiments of the present disclosure.

FIG. 10 is a simplified block diagram of the system for a customized chatbot using artificial intelligence according to some embodiments of the present disclosure.

FIG. 11 is a simplified diagram of an example graphical user interface in the system for a customized chatbot using artificial intelligence according to some embodiments of the present disclosure.

FIG. 12 is a simplified diagram of another example graphical user interface in the system for a customized chatbot using artificial intelligence according to some embodiments of the present disclosure.

FIG. 13 is a simplified flow diagram showing example operations for a customized chatbot using artificial intelligence according to some embodiments of the present disclosure.

FIGS. 14A and 14B are simplified flow diagrams showing other example operations for a customized chatbot using artificial intelligence according to some embodiments of the present disclosure.

### DETAILED DESCRIPTION

### Overview

For purposes of illustrating the embodiments described herein, it is important to understand certain terminology and operations of AI systems. The following foundational information may be viewed as a basis from which the present disclosure may be properly explained. Such information is offered for purposes of explanation only and, accordingly, should not be construed in any way to limit the broad scope of the present disclosure and its potential applications.

AI uses machine learning models to make predictions, recommendations, and classifications. In general, machine learning models use algorithms to parse data, learn from the parsed data, and make informed decisions based on what it has learned. According to some classifications, deep learning models are subsets of machine learning models, being machine learning algorithms that operate in multiple layers, creating an artificial neural network. According to some other classifications, machine learning models are those that rely on human intervention to learn, whereas deep learning models automatically learn without human intervention. Because the learning algorithms are more relevant to the disclosure herein than any human intervention to provide training data, the former classification is employed herein, such that wherever “machine learning models” is used, it is intended that deep learning models are included as well.

Deep learning models in particular, enable AI algorithms such as generative AI models (e.g., ChatGPT™). In a general sense, AI algorithms have three qualities that differentiate them from other algorithms: intentionality, intelligence, and adaptability. As intentional algorithms, they make decisions, often using real-time data, combining information from a variety of different sources, analyzing the combined information instantly, and acting on insights derived from such data. As intelligent algorithms, they are capable of spotting patterns in underlying data. As adaptable algorithms, they learn and adapt their analyses based on shifting input data.

Recent advances in AI have made possible commercially available AI engines that expose application programming interfaces (APIs) for other applications to consume. In a general sense, the API is a set of rules and protocols that defines how two software systems may communicate with each other. AI APIs allow advanced AI capabilities of the AI engine to be integrated into applications by allowing the application to make requests to the API and receiving responses. Thus, these applications provide, through the API, data to the AI engine, which runs machine learning models on the data to give suitable results as requested by the applications. Different AI engines may use different machine learning models, thereby providing different results to the same input data. Some AI engines may provide a certain functionality (e.g., text processing only) and some other AI engines may provide a certain other functionality (e.g., image processing only), while some others may provide multiple functionalities (e.g., text, speech, and image processing).

One of the applications that uses AI algorithms is a chatbot application. Typically, chatbot applications converse with users via human-like conversations in a chat (i.e., text) format. Hence, they are also called conversational agents. At the core of a chatbot application is a natural language processing (NLP) module that interprets a user's message and determines an appropriate text response using AI algorithms based on the identified interpretation. Some chatbots are trained to provide information specific to a particular domain, such as banking, finance, computer bug fixing, etc. Most standalone chatbot applications start and stop at this dialogue level, being programmed to reply to only a limited set of questions or statements from the user.

Virtual assistants have a broader range of functionalities compared to chatbots, such as being integrated with smart devices so that they set up alarms, schedule events, play music, etc. on the device with which they are integrated. Virtual assistants are typically voice-activated and hence also called voice assistants; they make recommendations based on previous user behaviors, provide different options for the user, collect data at the point of engagement, perform an action, such as schedule meetings, order products, provide feedback, or information about a product or service. While chatbots are commercially used by businesses (e.g., in a business to customer conversation), virtual assistants are typically used by individuals for interacting with the virtual assistant itself (i.e., virtual assistant does not converse on behalf of another). Some virtual assistants execute in a server in a cloud, performing their assistant functionalities, such as booking appointments or setting an alarm, in a user device remote from the server.

Apart from chatbots, there are various traditional ways in which businesses have traditionally interacted with their customers, such as via email, phone calls, in-person conversations, and online chat support to provide customer support, appointment scheduling, payment collection and such other customer-oriented services. These traditional interactions have associated drawbacks. Email and phone support may not be available 24/7, which can lead to delays in addressing customer queries. In-person conversations are limited by the availability of the business's physical location, which may not be accessible to all customers. Online chat support can be helpful, but it may not be customized to the location of the customer. Indeed, the costs for hiring, training, and onboarding a customer service employee can increase exponentially with multiple locations without necessarily providing any additional benefits over a chatbot. Additionally, traditional methods of appointment scheduling and payment collection require manual intervention, which can be time-consuming and prone to errors. This can lead to poor customer experience, which can impact business reputation and deal closure rate negatively. In summary, these traditional ways of customer support, appointment scheduling, and payment collection are limited by their availability, customization, and efficiency.

A customized and location-specific chatbot integrated with an AI engine having machine learning models as disclosed herein may alleviate such problems. In various examples, the chatbot may be trained on business-specific information to create a knowledge base comprising a base layer of information for interacting with the customer. The chatbot may also be configured to fulfill specific tasks or have a fixed intent that may trigger specific actions by the chatbot before it goes to sleep. In some examples, the chatbot may automatically schedule appointments. In other examples, the chatbot may collect information that may be mapped to custom fields or forms. In yet other examples, the chatbot may process payments by collecting card details and running the payment on the chatbot itself. In yet other examples, the chatbot may trigger marketing automation based on certain conditions, such as customer behavior or preferences. In yet other examples, the chatbot may provide technical support to the customer based on a repertoire of frequently asked questions (FAQs) and support documents.

In various examples, the chatbot may comprise several components, such as a NLP module to understand customer queries, a database to store information, a user interface to collect data about the business's products and services, machine learning models to analyze the data, expert systems including a knowledge base and inference engine to generate a recommended course of action in a response, and integrated back-end applications, such as a booking module to schedule appointments, a payment module to process payments, and a marketing automation module to trigger automated marketing campaigns. In some examples, the chatbot may have a user interface that customers interact with, the user interface including various interactive elements such as text input fields, and buttons. The UI may be configured to provide a seamless and intuitive customer experience.

In some examples, the chatbot may have two modes of operation: (1) suggestive mode in which the chatbot provides suggestions during conversations, and (2) auto-pilot mode, in which the chatbot responds to customers without human intervention based on an elaborate set of rules, triggers and conditions governing its behavior. In an example operation, the customer may initiate a conversation with the business by a message via one of many channels, including short messaging service (SMS), email, web application, etc. The chatbot may use its NLP module to understand the customer's message. In the suggestive mode, the chatbot may search its knowledge base comprising a database of information about the business's products and services to suggest an accurate and relevant response to the customer's message. The business user verifies the suggested response and forwards it to the customer.

In the auto-pilot mode, the chatbot may search its database of information about the business's products and services to provide an accurate and relevant response to the customer's message without human intervention. If the customer wants to schedule an appointment, the chatbot uses its booking module to suggest available times and dates and confirm the appointment. If the customer wants to make a payment, the chatbot collects the customer's card details and uses its payment module to process the payment. If the customer provides information that may be mapped to custom fields or forms, the chatbot collects and stores that information in its database. If a form is to be filled, the chatbot queries the customer for relevant information and automatically fills the form on behalf of the customer. Based on certain conditions, such as customer behavior or preferences, the chatbot triggers marketing automation to provide personalized and relevant marketing messages to the customer. In further examples, the chatbot's functionalities may be expanded over time by integrating other modules to perform more complex actions.

In various examples, the chatbot as disclosed herein may improve customer experience over traditional support channels such as email or phone by the chatbot's ability to understand natural language queries and provide immediate, personalized responses. The chatbot may handle multiple customer queries simultaneously (e.g., concurrently), freeing up human customer service representatives to focus on more complex tasks, possibly increasing efficiency and saving costs for the business. By providing location-specific information, i.e., tailoring its responses and behavior to the customer's location, the chatbot may help customers find relevant products or services they need more easily and quickly. The chatbot as disclosed herein may communicate with any number of customers concurrently, allowing for faster data collection from forms (e.g., surveys, questionnaires, etc.). In some examples, the chatbot's integration with appointment booking software may streamline the appointment booking process for the customer and reduce the need for customers to switch between multiple platforms. The chatbot's payment processing module may provide a secure and convenient way for customers to make payments, reducing the need for customers to share their credit card information with multiple platforms. By triggering marketing automation campaigns based on customer behavior and preferences, the chatbot may help businesses increase customer engagement and loyalty. In various examples, the chatbot as disclosed herein offers several advantages over other communication means in terms of improved customer experience, increased efficiency, location-specific information, streamlined booking process, secure payment processing, and personalized marketing automation.

In the following detailed description, various aspects of the illustrative implementations may be described using terms commonly employed by those skilled in the art to convey the substance of their work to others skilled in the art.

The term “connected” means a direct connection (which may be one or more of a communication, mechanical, and/or electrical connection) between the things that are connected, without any intermediary devices, while the term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), graphical processing unit (GPU), or other such electronic component capable of executing processes of a software algorithm.

The term “cloud network” means a network of computing devices coupled together in a public, private, or hybrid communications network. Communication in the cloud network may use one or more wired, wireless, broadband, radio, and other kinds of communicative means. The Internet is an example of a cloud network.

The description uses the phrases “in an embodiment” or “in embodiments,” which may each refer to one or more of the same or different embodiments.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

Note that the vocabulary of AI technology includes human-centric words such as “intent,” “reason,” “plan,” “learn,” “infer,” “strategize,” “create,” etc. To practitioners in the field, and as used herein, these terms have specific meanings relating to particular software methods, algorithms, and functionalities, such as searching, parsing, applying heuristic analysis, executing a neural network process, optimizing a particular function, etc., which are only roughly correspondent to their commonsense meanings. The use of these words in no way suggests that a human is performing the actions; rather they refer to software code executed by processing circuitry to perform specific functions.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various embodiments. Further, unless otherwise specified, the structures shown in the figures may take any suitable form or shape according to various design considerations, manufacturing processes, and other criteria beyond the scope of the present disclosure.

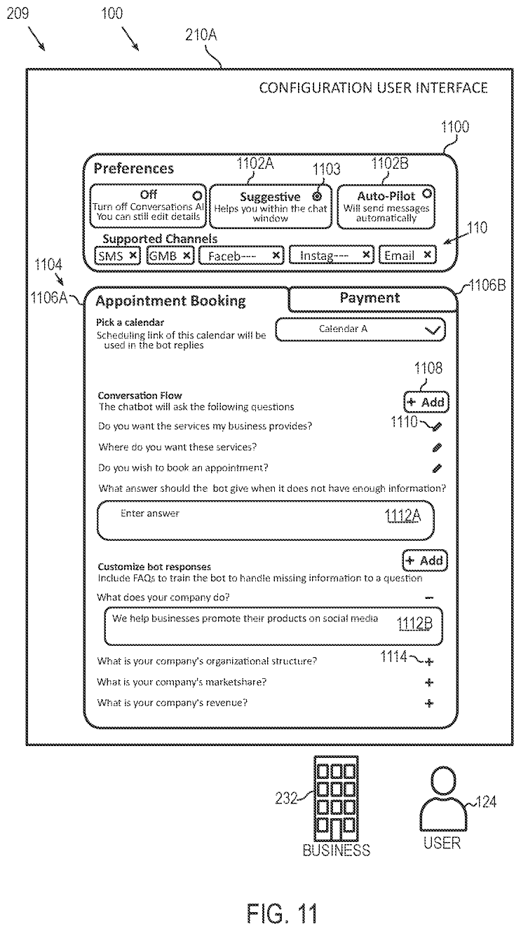

For convenience, if a collection of drawings designated with different letters are present (e.g., FIGS. 11A-11G), such a collection may be referred to herein without the letters (e.g., as “FIG. 11”). Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### Example Embodiments

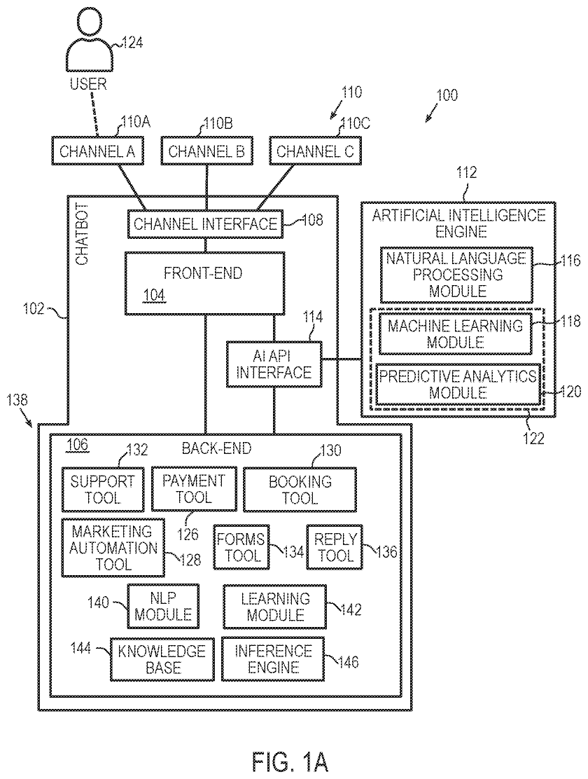

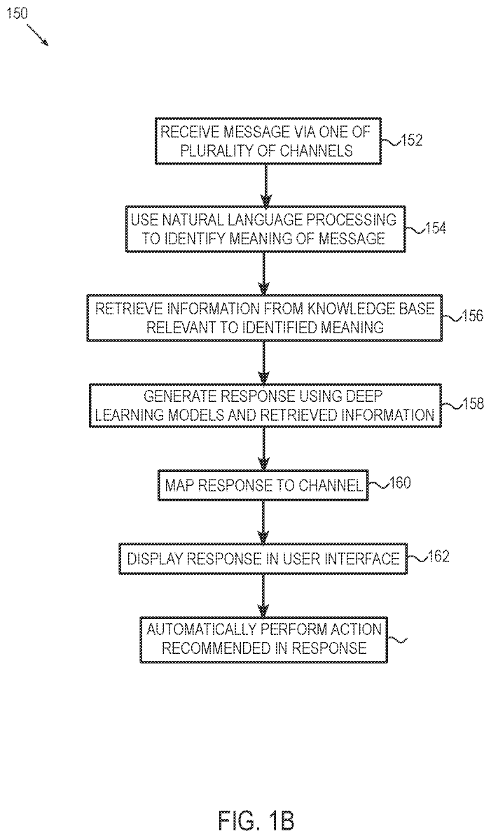

FIG. 1A is a simplified block diagram of an example system 100 for a customized chatbot 102 according to some embodiments of the present disclosure. Chatbot 102 may comprise a front-end 104, a back-end 106, and a channel interface 108. Channel interface 108 may facilitate communication with one or more channels 110, for example, channel 110a (channel A), channel 110b (channel B), and channel 110c (channel C). Any number of channels 110 may be provided in system 100 within the broad scope of the embodiments. Each channel 110 may be communicatively coupled to one or more applications executing in one or more computing devices separate from chatbot 102. For example, channel A may be communicatively coupled with an SMS application executing in a smartphone, channel B may be communicatively coupled with an email platform executing in a laptop, and channel C may be communicatively coupled with a web application such as a social media website executing in a web server. Channel interface 108 may have separate communication protocols for different channels 110. Each channel 110 may be configured to communicate messages from and to chatbot 102.

In some embodiments, chatbot 102 may interface with an external AI engine 112. In such embodiments, AI engine 112 may not be integrated within chatbot 102 but may execute independently and separately from chatbot 102. Examples of such external AI engine 112 include commercially available AI engines such as ChatGPT™, Intrasee™, Lex™, etc. Chatbot 102 may interact with external AI engine 112 using an AI API interface 114. In various examples, front-end 104 and back-end 106 may interact with AI engine 112 through AI API interface 114. AI API interface 114 may communicate with an AI API (not shown) in AI engine 112; the AI API is a set of routines, protocols, and tools that may allow chatbot 102 to access various functionalities of AI engine 112 through appropriate inputs and outputs. For example, front-end 104 may provide seed data to AI engine 112 through AI API interface 114.

AI engine 112 may comprise various modules, such as NLP module 116, machine learning module 118, and predictive analytics module 120. Machine learning module 118 and predictive analytics module 120 may form a learning module 122. NLP module 116 may comprise one or more NLP algorithms and models, such as Bidirectional Encoder Representations from Transformers (BERT) and Generative Pre-trained Transformer (GPT). Machine learning module 118 may include any suitable algorithm, such as unsupervised learning algorithms, supervised learning algorithms, and reinforcement learning models. Examples include regression models, classification models, tree-based models, etc. Deep learning models in machine learning module 118 may comprise one or more neural network algorithms, such as Convolutional Neural Networks (CNNs), Long Short Term Memory Networks (LSTMs), Recurrent Neural Networks (RNNs), Generative Adversarial Networks (GANs), Radial Basis Function Networks (RBFNs), Multilayer Perceptrons (MLPs), Self Organizing Maps (SOMs), Deep Belief Networks (DBNs), Restricted Boltzmann Machines (RBMs), Autoencoders and any other suitable algorithm as desired and based on particular needs.

In some embodiments, AI engine 112 may comprise a plurality of AI engines, each one comprising a subset of modules 116-122. For example, NLP module 116 may be provisioned in one AI engine 112a and learning module 122 may be provisioned in another AI engine 112b. In another example, machine learning module 118 may be provisioned in AI engine 112c, predictive analysis module 120 may be provisioned in yet another AI engine 112d, and so on. In such embodiments, AI API interface 114 in chatbot 102 may correspondingly comprise a plurality of AI API interfaces configured to interface with the appropriate external AI engines 112. Various such configurations are encompassed within the broad scope of the embodiments disclosed herein. The location of AI engine 112 as external to chatbot 102 may be agnostic to a user 124 (i.e., human user) who is interacting with chatbot 102. In other words, user 124 is not aware or made aware of the relative location of AI engine 112 with respect to chatbot 102, so that user 124 only experiences a seamless interaction with chatbot 102.

In various embodiments, inbound messages from one or more users 124 may be received by chatbot 102 via channels 110 through channel interface 108. Front-end 104 may process the messages and may output data, which is then consumed by AI API interface 114 and/or back-end 106. Examples of the output data are seed data for AI engine 112 and configuration data for manipulating the behavior of chatbot 102. Back-end 106 may comprise various tools 126-136 (e.g., applications, algorithms, software modules, code, etc.) configured to fulfill a plurality of intents 138.

Plurality of intents 138 comprises chatbot functionalities that are interpretations of corresponding desires conveyed by user 124 interacting with chatbot 102. For example, user 124 may click a “like” button on a social media platform, thereby sending a message to chatbot 102. Chatbot 102 may interpret this message as an approval to receive automated promotional emails related to the shoe and may initiate a marketing automation tool 128. In another example, user 124 may send a message, “My tooth is aching.” Chatbot 102 may interpret this message as a request for an appointment with a dentist and may initiate a booking tool 130. Chatbot may also (or alternatively) interpret this message as a troubleshooting question, and initiate a support tool 132, for example, to diagnose a more precise issue such as inflamed gums or misaligned braces for selection of the appropriate dentist with the correct specialty. In yet another example, user 124 may send a message, “I am ready to check-in.” Chatbot 102 may interpret this message as a form filling action and initiate a forms tool 134 to capture information about user 124. In yet another example, user 124 may send a message, “What is included in this detailing service?” Chatbot 102 may interpret this message as a request for information and may initiate a reply tool 136.

In some embodiments, tools 126-136 may be initiated in chatbot 102 by appropriate function calls. Thereafter, tools 126-136 may execute algorithms native to, or integrated with, other algorithms of chatbot 102. In other embodiments, a subset of functionalities of some or all of tools 126-136 may be external to chatbot 102 (e.g., executing in commercially available software platforms such as Google Calendar™, Calendly™, Acuity Scheduling™, PayPal™, Stripe™, Marketo™, HubSpot™, etc.), so that the remaining portion of such tools 126-136 integrated in chatbot 102 may comprise corresponding API interfaces. Such external functionalities may be called within chatbot 102 through the corresponding API interfaces. In various embodiments, the location of such functionalities, i.e., whether they are native to chatbot 102 or external thereto, may be agnostic to user 124. In other words, user 124 is not aware or made aware of the relative locations of tools 126-136 with respect to chatbot 102, so that user 124 is only interacting with chatbot 102 for fulfilling plurality of intents 138. In various embodiments, the functionalities of tools 126-136 may be provided to user 124 on a unified interface of chatbot 102, allowing user 124 to interact with a single platform to fulfill various ones in plurality of intents 138.

In addition, back-end 106 may further comprise various components of AI engines integrated therein, such as an NLP module 140, a learning module 142, and an expert system comprising a knowledge base 144 and an inference engine 146. NLP module 140 may be similar but not identical to NLP module 116 of external AI engine 112; learning module 142 may be similar but not identical to learning module 122 of external AI engine 112. In some embodiments, the NLP algorithms used in NLP module 140 and machine learning models used in learning module 142 may be as described in reference to NLP module 116 and learning module 122, respectively.

In various embodiments, knowledge base 144 stores information, such as information about a business, including customers, products, services, preferences, channels, protocols, etc. relevant to the operations of chatbot 102. Inference engine 146 applies logical rules, such as IF-THEN conditional rules to information in knowledge base 144 to deduce new information. For example, rules “if x, then y” and “if y, then z,” allow inference engine 146 to deduce new rule “if x, then z.” Heuristic rules may also be implemented in inference engine 146. Learning module 142 (or learning module 122) may be further used to generate rules for inference engine 146. Learning module 142 (or learning module 122) may apply machine learning models and predictive analysis on data in knowledge base 144 to generate the rules in various embodiments. Inference engine 146 may attach probability factors to the rules to generate recommendations. Such probably factors may be derived by learning module 142 (or learning module 122) in some embodiments. New rules derived by inference engine 146 may be fed back to learning module 142 to further enhance predictive capabilities of chatbot 102. Any suitable configuration applicable to AI engines may be provided in chatbot 102 within the broad scope of the embodiments herein. Various other tools and software modules may be integrated in chatbot 102 as desired and based on particular needs without departing from the scope of the disclosure.

During operation, chatbot 102 may receive a message from user 124 via one of channels 110, say channel 110a, which may be an SMS application such as WhatsApp™ or WeChat™. Front-end 104 may call NLP module 116 in AI engine 112 through AI API interface 114 to identify the meaning of the message in some embodiments. In other embodiments, front-end 104 may call NLP module 140 in back-end 104 to identify the meaning of the message. Depending on the identified meaning, relevant information may be retrieved from knowledge base 144. For example, the message may be an inquiry about a particular product offering. The information retrieved from knowledge base 144 may comprise specifications and pricing of the particular product offering. The information retrieved from knowledge base 144 may further comprise preferences of user 124, such as a preference to purchase the product immediately using a credit card. Such preference may have been stored in knowledge base 144 by chatbot 102 from a past transaction with user 124.

In various embodiments, the preference may trigger, using machine learning models, one in plurality of intents 138, for example, an intent to process payments using a credit card. Accordingly, information for processing credit card payments may be retrieved from knowledge base 144. Thereafter, chatbot 102 may generate, using at least one machine learning model by learning module 142 (or learning module 122), a response recommending an action to fulfill the intent. Reply tool 136 may craft the response comprising the specifications and pricing of the particular product offering along with an option to purchase it using a credit card. The response may be displayed on a user interface and/or sent to user 124 in an SMS message format appropriate to channel 110a. Chatbot 102 may automatically call payment tool 126, which may follow-up the response with more actions appropriate for accepting payments, such as a form for inputting credit card information, which may be sent to user 124 on channel 110a. From the perspective of user 124, all transactions are performed through chatbot 102 on channel 110a, without the need for changing channels (e.g., without switching from a chat application to an Internet browser). Various embodiments of chatbot 102 may offer several advantages in terms of improved customer experience, increased efficiency, location-specific information, streamlined booking process, secure payment processing, and personalized marketing automation when compared to traditional means of communication, such as human-operated telephone call centers.

Chatbot 102 as disclosed herein may be different from other chatbots in the range of functionalities it is capable of. For example, conventional chatbots may be capable only of sustaining a text-based dialogue with a human user; chatbot 102, on the other hand, can additionally automatically perform other functions within the chatbot software application, such as payment processing, for example, using payment tool 126. Chatbot 102 is also different from virtual assistants that are provisioned in a cloud network and operate on a remote device or external applications executing on the remote device. In contrast to such virtual assistants, chatbot 102 automatically performs actions using native applications that are integrated with chatbot 102. To the extent that chatbot 102 operates on external applications, such as AI engine 112, such operation is agnostic to user 124, so that user 124 experiences a seamless, single point of interaction, namely chatbot 102, to perform disparate actions, such as texting, payment processing, booking appointments, etc.

FIG. 1B is a simplified flow diagram showing example operations 150 associated with chatbot 102 according to some embodiments of the present disclosure. At 152, chatbot 102 may receive a message via one of plurality of channels 110. At 154, chatbot 102 may identify the meaning of the message using at least one NLP algorithm, for example, in NLP module 116 of external AI engine 112, or NLP module 140 native to chatbot 102. At 156, chatbot 102 may retrieve information from knowledge base 144. In various embodiments, the retrieved information may be relevant to the identified meaning of the message. In some embodiments, the message may comprise a transaction between a customer and a business, and knowledge base 144 may comprise data from past transactions between the customer and the business. In such embodiments, the information retrieved from knowledge base 144 may be both relevant to the identified meaning of the message and information related to past transactions between the customer and the business. In some other embodiments, knowledge base 144 may comprise past data from other transactions conducted by the business (e.g., similar transactions routinely conducted by the business). In such embodiments, the information retrieved from knowledge base 144 may be both relevant to the identified meaning of the message and information related to past transactions conducted by the business.

The information may further comprise attributes of plurality of intents 138. In some embodiments, plurality of intents 138 comprises payment processing, automated marketing actions, replying to the message, appointment booking, form filling, data storage, and troubleshooting (e.g., one or more errors, issues, problems, etc.). By way of examples, and not as limitations, attributes of sending a reply message may include one or more contact addresses of a recipient of the reply message and the corresponding channels 110 for sending the reply message; attributes of processing a payment may include credit card processing information, electronic funds transfer information, and wire transfer information (among others); attributes of booking an appointment may include one or more calendars associated with a sender of the message (e.g., user 124); attributes of filling a form may include one or more fields to be filled in the form; attributes of storing data may include one or more formats for data storage; attributes of troubleshooting one or more errors may include types of the one or more errors; and attributes of executing automated marketing actions may include types of marketing actions and corresponding channels for deploying the marketing actions.

At 158, chatbot 102 may generate, using at least one machine learning model in learning module 122 or learning module 142, a response recommending an action to fulfill one in plurality of intents 138. In various embodiments, the machine learning model may use the information retrieved from knowledge base 144 in operation 156 to derive the recommended action. In some embodiments, the recommended action may be more relevant to the meaning of the message identified in operation 154 than other actions to fulfill any intent in plurality of intents 138. For example, the message may be a request for information about a shoe sale at a particular store. While automated marketing actions, payment processing, appointment booking etc., are all possible actions with which to respond to the message, the action most relevant to the message may be to fetch from knowledge base 144 information about the shoe sale at the particular store and respond to the message accordingly. Thus, the recommended action is to send information about the shoe sale at the particular store. At 160, chatbot 102 may map a response comprising the recommended action to channel 110 on which the message was received. At 162, chatbot 102 may display the response in a user interface associated with front-end 104. At 164, chatbot 102 may automatically perform the recommended action.

Although various operations are illustrated in FIG. 1B once each, the operations may be repeated as often as desired, for example, when multiple users interact concurrently with chatbot 102. In such scenarios, chatbot 102 may generate different responses to such multiple messages concurrently, and automatically perform the recommended actions corresponding to the responses without human intervention.

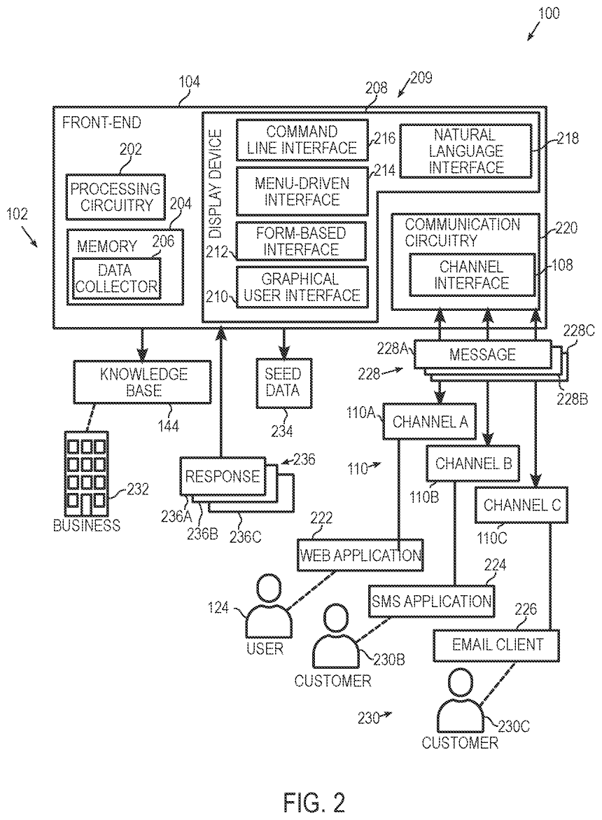

FIG. 2 is a simplified block diagram of example front-end 104 in chatbot 102 of system 100 according to some embodiments of the present disclosure. Front-end 104 may comprise a processing circuitry 202. As used herein, the term “processing circuitry” or “processing unit” or simply “processor” may refer to any device or portion of a device that processes electronic data from registers and/or memory to transform that electronic data into other electronic data that may be stored in registers and/or memory. Processing circuitry 202 may include one or more digital signal processors (DSPs), Application Specific Integrated Circuits (ASICs), CPUs, graphical processing units (GPUs), crypto processors (specialized processors that execute cryptographic algorithms within hardware), server processors, or any other suitable processing devices. Processing circuitry 202 may be part of a computing device in which front-end 104 is provisioned.

Front-end 104 may include non-transitory computer-readable media such as a memory 204, which may itself include one or more memory devices such as volatile memory such as dynamic random access memory (DRAM), nonvolatile memory (e.g., read-only memory (ROM)), flash memory, solid-state memory, and/or a hard drive. In some embodiments, memory 204 may include memory that shares a die with processing circuitry 202. Memory 204 may be part of the computing device in which front-end 104 is provisioned. Memory 204 may include algorithms, code, software modules, and applications, which may be executed by processing circuitry 202. In particular embodiments, memory 204 may include a data collector 206 comprising instructions for collecting and aggregating data.

Front-end 104 may include a display device 208. Display device 208 may include any visual indicators, such as a heads-up display, a computer monitor, a projector, a touchscreen display, a liquid crystal display (LCD), a light-emitting diode display, or a flat panel display, for example. Display device 208 may be configured to display one or more user interfaces 209 such as a graphical user interface (GUI) 210, a form-based interface 212, a menu-driven interface 214, a command line interface (CLI) 216, and a natural language interface 218. In some embodiments, only one such user interface 209 may be provisioned; in other embodiments, more than one such user interface 209 may be provisioned. Display device 208 may be connected to the computing device in which front-end 104 is provisioned in some embodiments. In other embodiments, display device 208 may be an integral part of the computing device in which front-end 104 is provisioned.

Front-end 104 may include communication circuitry 220 comprising one or more communication chips. For example, communication circuitry 220 may be configured for managing wireless communications for the transfer of data to and from front-end 104. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not.

Communication circuitry 220 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 220 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 220 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 220 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 220 may operate in accordance with other wireless protocols in other embodiments. Communication circuitry 220 may include antennas to facilitate wireless communications and/or to receive other wireless communications.

In some embodiments, communication circuitry 220 may manage wired communications, such as electrical, optical, or any other suitable communication protocols (e.g., the Ethernet, Internet). As noted above, communication circuitry 220 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

In various embodiments, communication circuitry 220 may be provisioned with channel interface 108, including various circuit elements and protocols for appropriately interfacing with plurality of channels 110, such as channel 110a, 110b and 110c. For example, channel interface 108 may be implemented in a network interface card having communication circuitry 220 and connected to the computing device provisioned with front-end 104. Any number of channels 110 may interface with channel interface 108 as described in reference to the previous figure.

In some embodiments, channel 110a may comprise a web application 222, such as a social media page. Channel 110b may comprise an SMS application 224. Channel 110c may comprise an email client 226. Note that these applications are merely provided as examples and not as limitations. Some embodiments may support only one type of channel 110; some other embodiments may support two types, and so on. Channels 110 may be configured to communicate one or more messages 228 with chatbot 102. For example, channel 110a may communicate message 228a, channel 110b may communicate message 228b, channel 110c may communicate message 228c, etc.

One or more such messages 228 may comprise one or more transactions between two entities, such as customers 230 and a business 232 in one example. Note that messages 228 may be sent between two individuals and/or between two businesses without departing from the scope of the embodiments. Messages 228 may be communicated through respective applications, such as web application 222, or email client 226 (by way of examples), or may be entered in appropriate user interfaces 209, such as GUI 210 or menu-driven interface 214 (by way of examples). In one example, user 124, who may be a representative or employee of business 232 or one of customers 230, may log into web application 222, which may then present GUI 210 in a browser of web application 222. Data entered into GUI 210 may be sent as message 228A over channel 110a, and collected by data collector 206, which may thereafter send it to knowledge base 144 or aggregate it into seed data 234 for presenting to AI engine 112 (not shown).

In some embodiments, user 124 may send message 238a over channel 110a to configure chatbot 102 with information about business 232, such that data extracted from message 238a by data collector 206 may be stored in knowledge base 144 for future operations. In some embodiments, message 228a may be further presented to user 124 in GUI 210 separate from web application 222. In another embodiment, a customer 230b may send message 238b over channel 110b, using menu-driven interface 214, to request an appointment with a representative of business 232, such that data extracted from message 238b by data collector 206 may be fed as seed data 234 to AI engine 112 (not shown). In yet another embodiment, customer 230c may send message 228c over channel 110c; by way of example, and not as a limitation, message 228c may be an email inquiry about a product (e.g., shoes) with preferences of the customer (e.g., shoe size) provided therein, such that data extracted from message 238a by data collector 206 may be stored in knowledge base 144 for future operations and populated in seed data 234 for AI engine 112. In various embodiments, knowledge base 144 may be populated over time with data extracted from messages 228. Such data may include information about business 232, customers 230, and/or user 124 as desired and based on particular needs.

In various embodiments, one or more responses 236 may be generated by chatbot 102 (e.g., using back-end 106 and/or AI engine 112). Response 236 may be sent as one or more messages 238 over corresponding channels 110, and/or displayed in suitable user interface 209 in display device 208. In some embodiments, front-end 104 may map responses 236 to channels 110 corresponding to messages 228 appropriately. For example, response 236a may be mapped to channel 110a corresponding to message 228a; response 236b may be mapped to channel 110b corresponding to message 228b; response 236c may be mapped to channel 110c corresponding to message 228c. By way of examples and not as limitations, response 236a may be displayed on GUI 210 relevant to corresponding channel 110a (e.g., in web application 222); response 236b may be displayed in a menu-driven interface relevant to corresponding channel 110b (e.g., in SMS application 224); and so on.

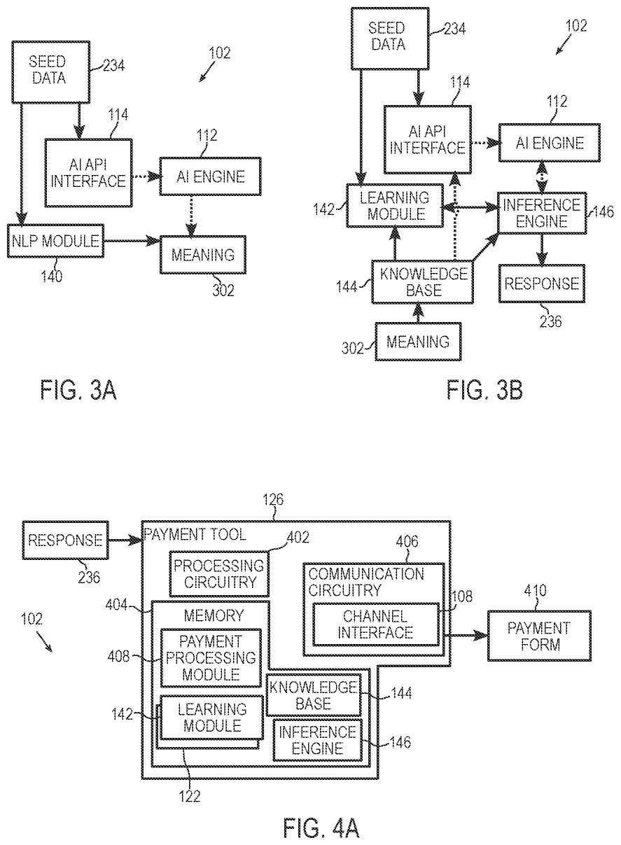

FIGS. 3A and 3B are simplified block diagrams of example AI features in chatbot 102 according to some embodiments of the present disclosure. As shown in FIG. 3A, seed data 234 extracted from messages 228 (not shown) may be fed to AI engine 112 via AI API interface 114 and/or NLP module 140 to identify a meaning 302 of message 228. In various embodiments, meaning 302 may indicate one of plurality of intents 138 (not shown). For example, message 228 may comprise an email inquiry, “My tooth is aching. Do you have a dentist who can see me?” In some embodiments, seed data 234 may include words used in message 228, for example, “my,” “tooth,” “aching,” “dentist,” “see,” etc. In other embodiments, seed data 234 may include the entirety of message 228. AI engine 112 and/or NLP module 140 may analyze seed data 234 and identify meaning 302 to be an inquiry for immediate dental services by a dentist, indicative of a first intent to gather information about dental services and a second intent to book an appointment with the dentist immediately. Various other possibilities in interpretation are included within the broad scope of the embodiments.

As shown in FIG. 3B, seed data 234 extracted from messages 228 (not shown) may be fed to AI engine 112 via AI API interface 114 and/or learning module 142 to generate suitable response 236. AI engine 112 and/or learning module 142 may also consume data from knowledge base 144 for analyzing seed data 234. In various embodiments, knowledge base 144 may comprise data from past transactions. For example, the information may include data from past transactions between customers 230 and business 232. In some embodiments, knowledge base 144 may include data from past transactions conducted by business 232. In some embodiments, meaning 302 may be stored in knowledge base 144 and used for the analysis. Inference engine 146 may apply suitable rules generated by learning module 142 and/or AI engine 112 on data in knowledge base 144 and seed data 234 to generate response 236. In various embodiments, response 236 may comprise a recommended action to fulfill one of plurality of intents 138 indicated by meaning 302.

In various embodiments, learning module 142 and/or AI engine 112, in conjunction with inference engine 146, may apply at least one machine learning model on information retrieved from knowledge base 144 to derive the recommended action in response 236. In some embodiments, the recommended action may be arrived at by eliminating other actions that are deemed to be less relevant to meaning 302.

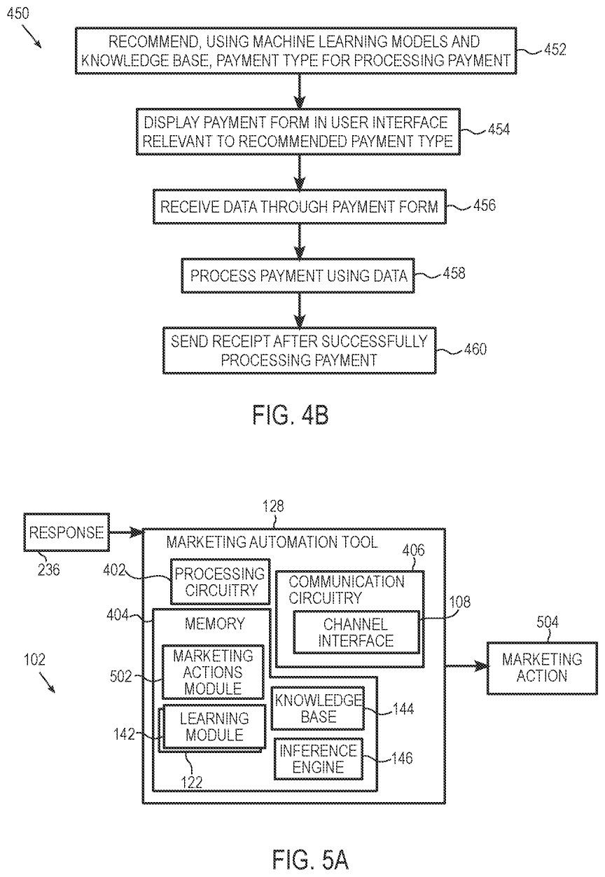

FIG. 4A is a simplified block diagram of payment tool 126 of chatbot 102 according to some embodiments of the present disclosure. In various embodiments, the recommended action in response 236 may be to process a payment. In such embodiments, payment tool 126 may be automatically initiated in chatbot 102, for example, by executing an appropriate function call. Payment tool 126 comprises a processing circuitry 402, a memory 404, and a communication circuitry 406 provisioned with channel interface 108. In various embodiments, processing circuitry 402, memory circuit 404 and communication circuitry 406 may be similar, or substantially identical in structure to processing circuitry 202, memory 204, and communication circuitry 220, respectively, as described in FIG. 2. In some embodiments in which front-end 104 is provisioned in a computing device separate from back-end 106, processing circuitry 402, memory 404, and communication circuitry 406 may not be in the same computing device as processing circuitry 202, memory 204, and communication circuitry 220. In embodiments in which front-end 104 and back-end 106 are provisioned in the same computing device, processing circuitry 402, memory circuitry 404, and communication circuitry 406 may be substantially same as processing circuitry 202, memory 204, and communication circuitry 220, respectively.

Memory 404 may be provisioned with a payment processing module 408, learning modules 142 (and/or learning module 122), knowledge base 144 and inference engine 146, all of which comprise instructions for performing specific operations by processing circuitry 402. In various embodiments, payment processing module 408 may be configured with instructions to process a plurality of payment types, for example, credit card payment, electronic funds transfer, and wire transfers, among others. In some embodiments, payment processing module 408 may comprise instructions configured to interface with external payment systems such as PayPal™ to process the payment. In various embodiments, payment tool 126 may display a payment form 410 in user interface 209 that is suitable to the payment type. User 124 (not shown) may input data into payment form 410, for example, invoice number, credit card number, bank routing information, etc. The input data may be received by payment tool 126 and processed suitably according to the payment type.

In various embodiments, payment tool 126 may recommend, using one or more machine learning models in learning module 142 (or alternatively learning module 122 in external AI engine 112), knowledge base 144 and inference engine 146, the one or more payment types and may send corresponding payment form 410 to user interface 209. For example, information in knowledge base 144 may indicate that user 124 has paid using credit cards in the past more often than electronic funds transfers. Payment tool 126 may therefore recommend payment by credit card and send appropriate credit card form as payment from 410 to user interface 209. After successful completion of payment, by payment processing module 408, a receipt may be displayed on user interface 209 and/or sent to user 124 on appropriate channel 110.

FIG. 4B is a simplified flow diagram showing example operations 450 associated with payment tool 126 according to some embodiments of the present disclosure. In various embodiments, payment tool 126 may be initiated by a recommendation to process a payment in response 236. Upon initiation, at 452, inference engine 146 in payment tool 126 may recommend, using one or more machine learning models in learning module 142 (or learning module 122), one in a plurality of payment types for processing the payment. In various embodiments, the machine learning models may use knowledge base 144 to derive the recommended payment type. For example, the information in knowledge base 144 may indicate that the business does not have the capability to process wire transfers, and hence the recommended payment type may not include wire transfers. In another example, the information in knowledge base 144 may indicate that user 124 has previously used a credit card for payment and hence the recommended payment type maybe for a credit card. At 454, payment tool 126 may display payment form 410 in user interface 209, payment form 410 being relevant to the recommended payment type. For example, the recommended payment type may be a credit card, the payment form 410 includes fields to fill in credit card information. At 456, payment tool 126 may receive data through payment form 410 from user 124. At 458, payment processing module 408 may process the payment using the received data. At 460, payment tool 126 may send a receipt after successfully processing the payment.

Although various operations are illustrated in FIG. 4B once each, the operations may be repeated as often as desired, for example, when multiple customers 230 interact concurrently with chatbot 102. In such scenarios, chatbot 102 may generate different responses 236 to such multiple messages 228 concurrently, and automatically perform the recommended actions corresponding to responses 236 without human intervention. For example, customer 230a may prefer paying by credit card and another customer 230b may prefer paying by electronic funds transfer; payment tool 126 may appropriately automatically generate separate forms for customers 230a and 230b without any human intervention.

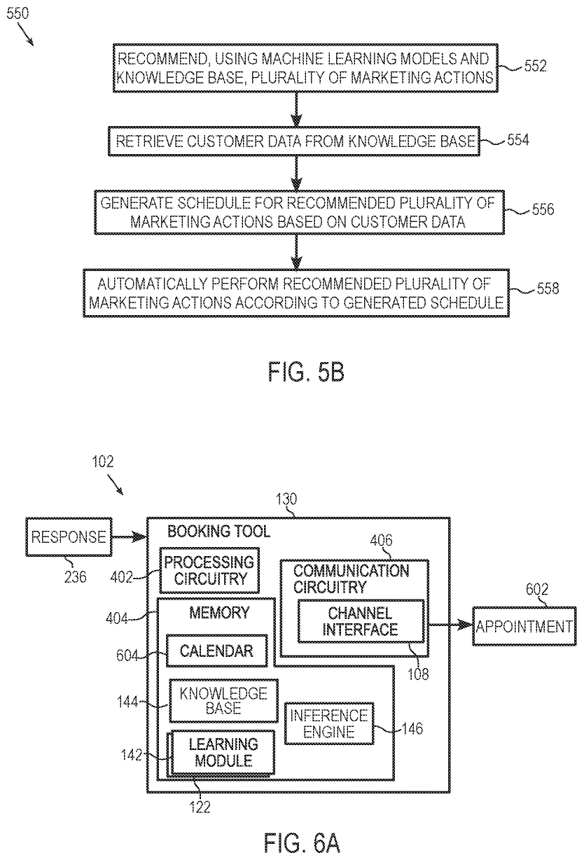

FIG. 5A is a simplified block diagram of marketing automation tool 128 of chatbot 102 according to some embodiments of the present disclosure. In various embodiments, the recommended action in response 236 may be to automate certain marketing actions. In such embodiments, marketing automation tool 128 may be automatically initiated in chatbot 102, for example, by executing an appropriate function call. Marketing automation tool 128 comprises processing circuitry 402, memory 404, and communication circuitry 406 provisioned with channel interface 108. In various embodiments, processing circuitry 402, memory circuit 404 and communication circuitry 406 may be similar, or substantially identical, in structure to processing circuitry 202, memory 204, and communication circuitry 220, respectively, as described in FIG. 2. In some embodiments in which front-end 104 is provisioned in a computing device separate from back-end 106, processing circuitry 402, memory 404, and communication circuitry 406 may not be in the same computing device as processing circuitry 202, memory 204, and communication circuitry 220, respectively. In embodiments in which front-end 104 and back-end 106 are provisioned in the same computing device, processing circuitry 402, memory circuitry 404, and communication circuitry 406 may be substantially same as processing circuitry 202, memory 204, and communication circuitry 220, respectively.

Memory 404 may be provisioned with a marketing actions module 502, learning module 142 (and/or learning module 122), knowledge base 144 and inference engine 146, all of which comprise instructions for performing specific operations by processing circuitry 402. In various embodiments, marketing actions module 502 may be configured with means to recommend, select, or perform various marketing actions, such as creating an email campaign, creating a social media campaign, generating a list of leads, etc. Upon initiation, inference engine 146 in marketing automation tool 128 may recommend one or more marketing actions suitable to response 236. For example, inbound message 228 from customer 230b may be, “I am looking for wedge shoes.” Response 236 may comprise a recommendation to send promotional emails to customer 230b about wedge shoes. Marketing actions module 502 may analyze information in knowledge base 144 related to customer 230b and wedge shoes (or similar shoes) using at least one machine learning model. The information may suggest, by way of example, and not as a limitation, that customer 230b responds to promotional emails, and also follows shoe sales in specific locations promoted on certain social media platforms. The information may further indicate, by way of example, and not as a limitation, that business 232 has shoe sales scheduled for three consecutive weeks in May in one of the specific locations relevant to customer 230b.

Based on the analysis, marketing actions module 502 may recommend that customer 230b should be enrolled into email marketing campaigns for shoes as well as be sent social media posts about wedge shoe sales in the specific locations relevant to customer 230B. Marketing actions module 502 may also generate a schedule for the automated email campaigns in view of the shoe sales scheduled for three consecutive weeks in May. These marketing recommendations may be aggregated into marketing actions 504 and executed accordingly. For example, an email marketing campaign tool may be initiated according to the schedule; a social media platform may be contacted with information about posts to customer 230B; and so on. Any suitable marketing action that can be automated reasonably may be included within the broad scope of the embodiments. In some embodiments, external marketing tools, such as Marketo™ and HubSpot™ may also be used with appropriate API interfaces by marketing automation tool 128. For example, some marketing actions 504 may be performed by marketing actions module 502 and certain other marketing actions 504 may be performed by external marketing tools. Any such suitable combination may be included as desired and based on particular needs within the broad scope of the embodiments.

FIG. 5B is a simplified flow diagram showing example operations 550 associated with marketing automation tool 128 according to some embodiments of the present disclosure. Upon initiation, at 552, marketing automation tool 128 may recommend, using one or more machine learning models in learning module 142 (or learning module 122), a plurality of marketing actions 504 relevant to response 236. In various embodiments, the machine learning models may use knowledge base 144 to derive the recommended plurality of marketing actions 504, as described in reference to FIG. 5A. At 554, customer data may be retrieved from knowledge base 144. Such customer data may include, by way of examples and not as limitations, the location of the customer, customer preferences and past behavior relevant to the marketing actions, past transactions with the customer, etc. At 556, marketing action module 502 may generate a schedule for the recommended marketing actions 504. At 558, marketing automation tool 128 may automatically perform recommended marketing actions 504 according to the generated schedule.

Although various operations are illustrated in FIG. 5B once each, the operations may be repeated as often as desired, for example, when multiple customers 230 interact concurrently with chatbot 102. In such scenarios, chatbot 102 may generate different responses 236 to such multiple messages 228 concurrently, and automatically perform the recommended actions corresponding to responses 236 without human intervention. For example, customer 230a may prefer receiving emails and another customer 230b may respond better to social media posts; marketing automation tool 128 may appropriately automatically generate separate marketing actions 504 for customer 230a and 230b without any human intervention.

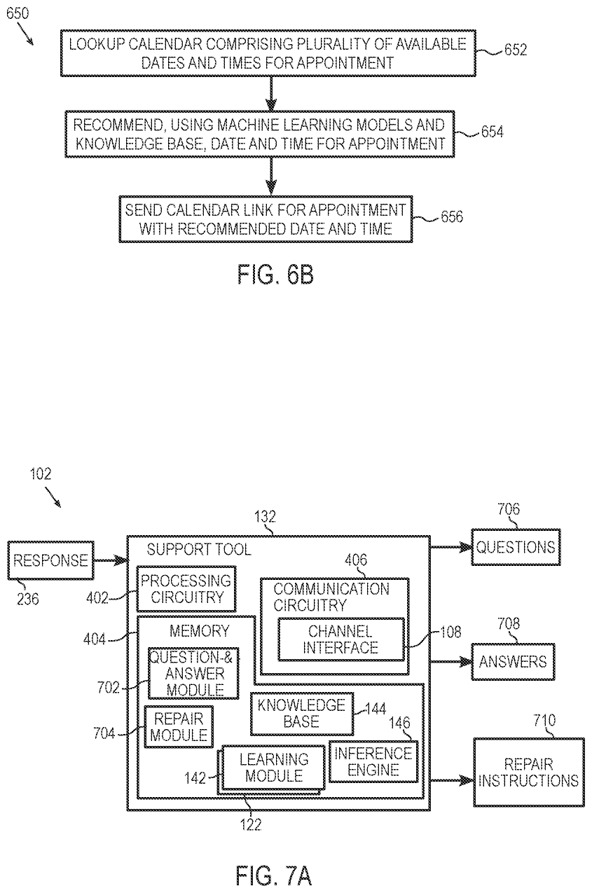

FIG. 6A is a simplified block diagram of booking tool 130 of chatbot 102 according to some embodiments of the present disclosure. In various embodiments, the recommended action in response 236 may be to book an appointment 602. In such embodiments, booking tool 130 may be automatically initiated in chatbot 102, for example, by executing an appropriate function call. Booking tool 130 comprises processing circuitry 402, memory 404, and communication circuitry 406 provisioned with channel interface 108. In various embodiments, processing circuitry 402, memory circuit 404 and communication circuitry 406 may be similar, or substantially identical, in structure to processing circuitry 202, memory 204, and communication circuitry 220, respectively, as described in FIG. 2. In some embodiments in which front-end 104 is provisioned in a computing device separate from back-end 106, processing circuitry 402, memory 404, and communication circuitry 406 may not be in the same computing device as processing circuitry 202, memory 204, and communication circuitry 220, respectively. In embodiments in which front-end 104 and back-end 106 are provisioned in the same computing device, processing circuitry 402, memory circuitry 404, and communication circuitry 406 may be substantially same as processing circuitry 202, memory 204, and communication circuitry 220, respectively.

Memory 404 may be provisioned with a calendar 604, learning module 142 (and/or learning module 122), knowledge base 144 and inference engine 146, all of which comprise instructions for performing specific operations by processing circuitry 402. In various embodiments, booking tool 130 may comprise instructions for looking up a calendar 604. Calendar 604 may be configured with a plurality of available dates and times for appointment 602. In some embodiments, calendar 604 may be external to chatbot 102, for example, on an external platform such as Google Calendar™. In some embodiments, calendar 604 may be native to chatbot 102. In some embodiments, a plurality of calendars 604 may be provisioned in booking tool 130. For example, user 124 may specify one calendar for a personal profile and another calendar for a business profile. In another example, user 124 may specify separate calendars for different social media platforms. In yet another example, separate calendars 604 may be provisioned for separate employees of business 232; and so on. In various embodiments, inference engine 146 in booking tool 130 may recommend, using one or more machine learning models in learning module 142 (or learning module 122), a date and time in the plurality of available dates and times for appointment 602. The one or more machine learning models may use knowledge base 144 to derive the recommended date and time.

For example, message 228 may comprise an email inquiry from customer 230, “My tooth is aching. Do you have a dentist who can see me?” The information in knowledge base 144 may indicate, by way of example and not as a limitation, that customer 230 had been at the dentist a week ago to fix an infected tooth and that Dentist A had performed the dental services. Learning module 142 may further determine, based on machine learning models using information relevant to dental services stored in knowledge base 144, that persistent pain may need to be checked immediately. Booking tool 130 may retrieve calendars of other dentists at business 232 if it is determined that Dentist A is not available immediately. A suitable dentist may be identified with immediate availability, and a calendar link for appointment 602 with the recommended date and time may be sent to customer 230. In various embodiments, the calendar link may be appropriate to the particular software platform of calendar 604, for example, Google Calendar™, Outlook Calendar™, etc. as inferred from similar past transactions stored in knowledge base 144. Note that various other examples and scenarios are possible within the broad scope of the embodiments.

FIG. 6B is a simplified flow diagram showing example operations 650 associated with booking tool 130 according to some embodiments of the present disclosure. At 652, booking tool 130 may lookup calendar 604 comprising plurality of available dates and times for appointment 602. At 654, inference engine 146 in booking tool 130 may recommend, using machine learning models of learning module 142 (or learning module 122), and based on information in knowledge base 144, a suitable date and time for appointment 602. At 656, booking tool 130 may send a calendar link for appointment 602 with the recommended date and time over appropriate channel 110. For example, if message 228 was received at chatbot 102 over channel 110a, response 236 with appointment 602 may be sent over the same channel 110a.

Although various operations are illustrated in FIG. 6B once each, the operations may be repeated as often as desired, for example, when multiple customers 230 interact concurrently with chatbot 102. In such scenarios, chatbot 102 may generate different responses 236 to such multiple messages 228 concurrently, and automatically perform the recommended actions corresponding to responses 236 without human intervention. For example, customer 230a may prefer receiving a calendar link via email and another customer 230b may prefer receiving the calendar link via text; booking tool 130 may appropriately automatically generate separate calendar links for customers 230a and 230b without any human intervention.

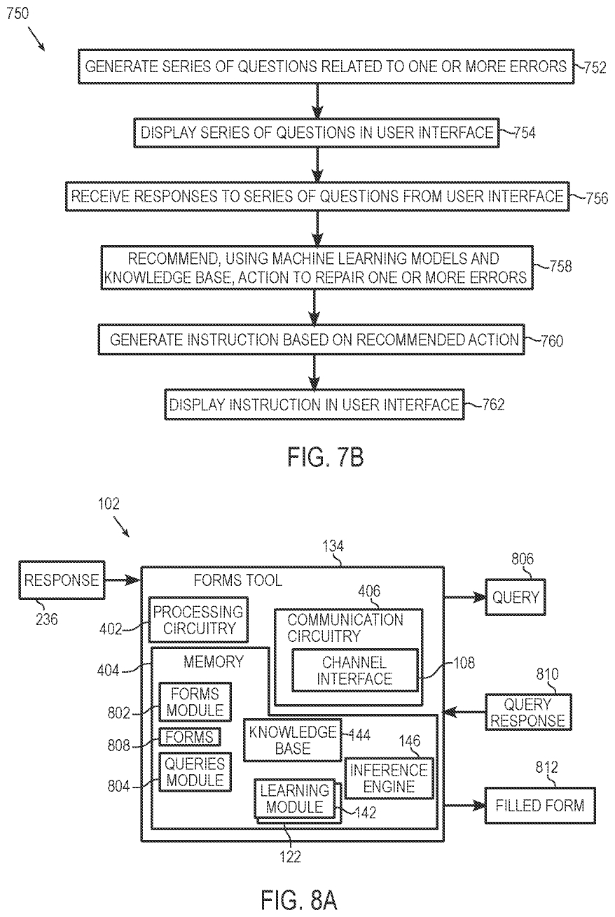

FIG. 7A is a simplified block diagram of support tool 132 in chatbot 102 according to some embodiments of the present disclosure. In various embodiments, the recommended action in response 236 may be to perform one or more repairs. In such embodiments, support tool 132 may be automatically initiated in chatbot 102, for example, by executing an appropriate function call. Support tool 132 comprises processing circuitry 402, memory 404, and communication circuitry 406 provisioned with channel interface 108. In various embodiments, processing circuitry 402, memory circuit 404 and communication circuitry 406 may be similar, or substantially identical, in structure to processing circuitry 202, memory 204, and communication circuitry 220, respectively, as described in FIG. 2. In some embodiments in which front-end 104 is provisioned in a computing device separate from back-end 106, processing circuitry 402, memory 404, and communication circuitry 406 may not be in the same computing device as processing circuitry 202, memory 204, and communication circuitry 220, respectively. In embodiments in which front-end 104 and back-end 106 are provisioned in the same computing device, processing circuitry 402, memory circuitry 404, and communication circuitry 406 may be substantially same as processing circuitry 202, memory 204, and communication circuitry 220, respectively.

Memory 404 may be provisioned with a question-and-answer module 702, a repair module 704, learning module 142 (and/or learning module 122), knowledge base 144 and inference engine 146, all of which comprise instructions for performing specific operations by processing circuitry 402. In various embodiments, question-and-answer module 702 may comprise instructions for generating a series of questions related to one or more errors relevant to message 228. For example, message 228 may be, “My tooth is aching.” Question-and-answer module 702 may generate questions 706 to determine whether the tooth ache is from an infection or from misaligned braces. An example question may be, “Are you wearing braces?” The expected answer may be “Yes,” or “No.” Depending on answers 708, questions 706 may branch to other relevant questions 706. For example, if answer 708 is “No,” question-and-answer module 702 may ask further questions 706, such as, “Do you have a fever?” etc. In another example, message 228 may be, “My computer is not working.” Question-and-answer module 702 may generate questions 706 to determine whether the error arose from the computer or from the network. Depending on answers 708 to questions 706, question-and-answer module 702 may branch out and ask further questions 706 to pinpoint the error.

In various embodiments, the series of questions 706 may be displayed in user interface 209 and answers 708 captured therefrom accordingly. Based on the series of questions 706 and answers 708, repair module 704 may recommend an action and generate corresponding repair instructions 710. For example, in response to message 228 comprising, “My tooth is aching,” repair module 704 may use one or more machine learning models in learning module 142 (or learning module 122) based on information in knowledge base 144 to determine that the toothache is likely repaired with a root canal procedure. Inference engine 146 may recommend booking an appointment with the specialist dentist for the procedure based on the conclusion that the root canal procedure is recommended. In some embodiments, the recommended action may further trigger (e.g., initiate, start, execute) other modules in chatbot 102, for example, booking tool 130. In other words, repair instructions 710 may include instructions to initiate other modules in chatbot 102 based on the recommended action. In some embodiments, repair instructions 710 may be displayed in human readable form in user interface 209.

FIG. 7B is a simplified flow diagram showing example operations 750 associated with support tool 132 according to some embodiments of the present disclosure. At 752, question-and-answer module 702 in support tool 132 may generate a series of questions 706 related to one or more errors indicated in message 228. At 754, support tool 132 may display the series of questions 706 in user interface 209. At 756, support tool 132 may receive answers 708 to the series of questions 706 from user interface 209. At 758, repair module 704, using inference engine 146 in support tool 132, may recommend, using one or more machine learning models in learning module 142 (or learning module 122), an action to repair the one or more errors. In various embodiments, the machine learning models may use knowledge base 144 to derive the recommended repair action. At 760, repair module 704, using inference engine 146 in support tool 132, may generate an instruction (e.g., repair instruction 710) based on the recommended repair action. At 762, support tool 132 may display the instruction in user interface 209.

Although various operations are illustrated in FIG. 7B once each, the operations may be repeated as often as desired, for example, when multiple customers 230 interact concurrently with chatbot 102. In such scenarios, chatbot 102 may generate different responses 236 to such multiple messages 228 concurrently, and automatically perform the recommended actions corresponding to responses 236 without human intervention. For example, customer 230a may have a computer issue and another customer 230b may have a network issue; support tool 132 may appropriately automatically generate separate repair instructions 710 for customers 230a and 230b without any human intervention.

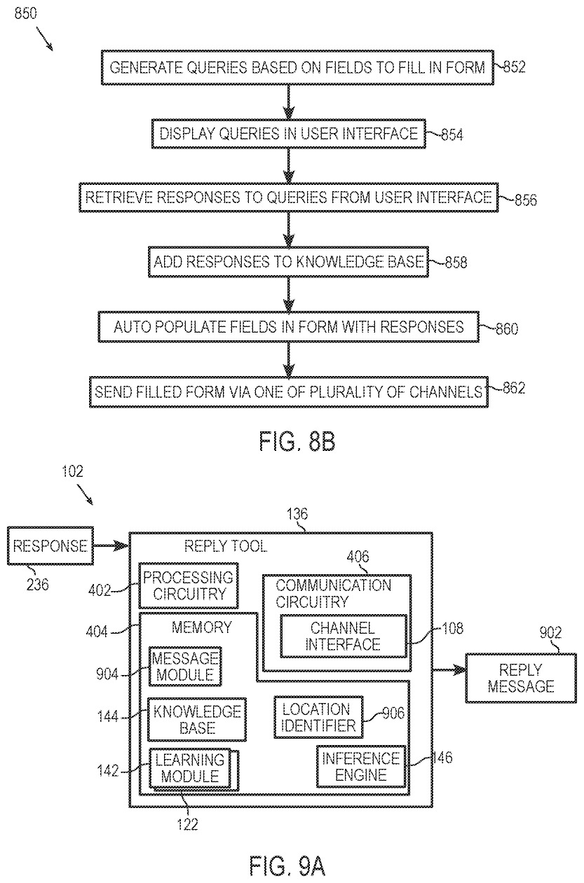

FIG. 8A is a simplified block diagram of forms tool 134 in chatbot 102 according to some embodiments of the present disclosure. In various embodiments, the recommended action in response 236 may be to fill one or more forms, for example, to obtain more information from user 124. In such embodiments, forms tool 134 may be automatically initiated in chatbot 102, for example, by executing an appropriate function call. Forms tool 134 comprises processing circuitry 402, memory 404, and communication circuitry 406 provisioned with channel interface 108. In various embodiments, processing circuitry 402, memory circuit 404 and communication circuitry 406 may be similar, or substantially identical, in structure to processing circuitry 202, memory 204, and communication circuitry 220, respectively, as described in FIG. 2. In some embodiments in which front-end 104 is provisioned in a computing device separate from back-end 106, processing circuitry 402, memory 404, and communication circuitry 406 may not be in the same computing device as processing circuitry 202, memory 204, and communication circuitry 220, respectively. In embodiments in which front-end 104 and back-end 106 are provisioned in the same computing device, processing circuitry 402, memory circuitry 404, and communication circuitry 406 may be substantially same as processing circuitry 202, memory 204, and communication circuitry 220, respectively.

Memory 404 may be provisioned with a forms module 802, a queries module 806, learning module 142 (and/or learning module 122), knowledge base 144 and inference engine 146, all of which comprise instructions for performing specific operations by processing circuitry 402. In various embodiments, the recommended action in response 236 may be to fill a form. In such embodiments, response 236 may initiate forms tool 134 automatically. Queries module 804 may generate one or more queries 806 based on fields to be filled in one or more forms 808 and send to user interface 209.

For example, form 808 may be a complicated form, such as a tax form. Queries 806 related to form 808 may include questions such as “What is your bi-weekly salary?” “Are you enrolled in a retirement plan?” “How many children do you have?” etc. Forms tool 134 may display queries 806 in user interface 209. Forms tool 134 may receive respective query responses 810 from user interface 209 and may add the received responses to knowledge base 144. Forms module 802 may thereafter auto-populate fields in form 808 with information extracted from query responses 810 and send filled form 812 via one of plurality of channels 110. In various embodiments, forms tool 134 may translate complex fields in form 808 to more user-friendly queries 806 and present to user 124 in user interface 209. Query responses 810 received from user 124 may be translated into information that can be used to fill form 808 suitably. For example, in response to a query 806, “Hi, what is your name?”, query response 810 may be the sentence, “Hi, my name is John Doe.” Forms module 802 may parse query response 810, extract the words “John Doe” and fill the appropriate field in form 808 with the extracted information.

FIG. 8B is a simplified flow diagram showing example operations 850 associated with forms tool 134 according to some embodiments of the present disclosure. At 852, query module 804 in forms tool 134 may generate queries 806 based on fields to be filled in form 808. At 854, forms tool 134 may display queries 806 in user interface 209. At 856, forms tool 134 may receive responses to queries 806 from user interface 209. At 858, forms tool 134 may add the responses to knowledge base 144. At 860, forms tool 134 may auto-populate the fields in form 808 with the responses. At 862, forms tool 134 may send filled form 812 via one of the plurality of channels 110.

Although various operations are illustrated in FIG. 8B once each, the operations may be repeated as often as desired, for example, when multiple customers 230 interact concurrently with chatbot 102. In such scenarios, chatbot 102 may generate different responses 236 to such multiple messages 228 concurrently, and automatically perform the recommended actions corresponding to responses 236 without human intervention. For example, customer 230a may have one set of query responses 810 and another customer 230b may have another set of query responses 810; forms tool 134 may appropriately automatically generate separate filled forms 812 for customers 230a and 230b without any human intervention.

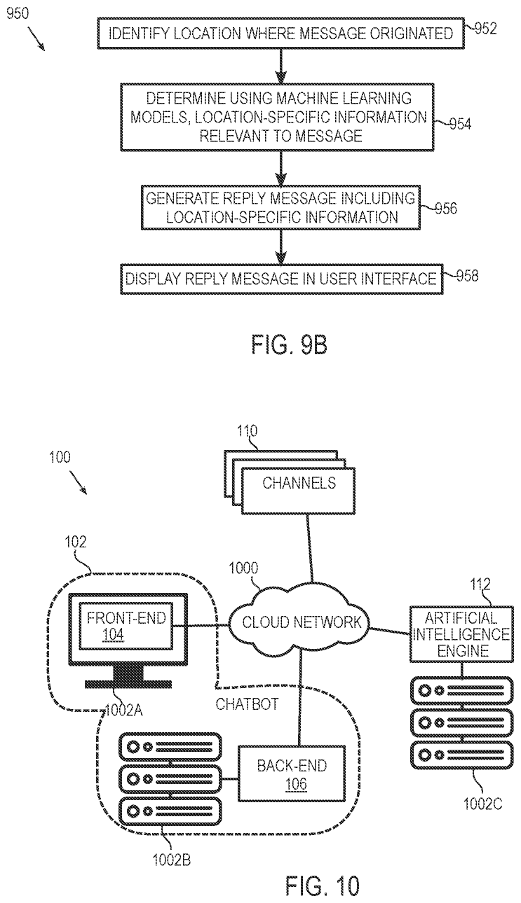

FIG. 9A is a simplified block diagram of an example reply tool in the system for a customized chatbot using AI according to some embodiments of the present disclosure. In various embodiments, the recommended action in response 236 may be to send a reply message 902. In such embodiments, reply tool 136 may be automatically initiated in chatbot 102, for example, by executing an appropriate function call. Reply tool 136 comprises processing circuitry 402, memory 404, and communication circuitry 406 provisioned with channel interface 108. In various embodiments, processing circuitry 402, memory circuit 404 and communication circuitry 406 may be similar, or substantially identical, in structure to processing circuitry 202, memory 204, and communication circuitry 220, respectively, as described in FIG. 2. In some embodiments in which front-end 104 is provisioned in a computing device separate from back-end 106, processing circuitry 402, memory 404, and communication circuitry 406 may not be in the same computing device as processing circuitry 202, memory 204, and communication circuitry 220, respectively. In embodiments in which front-end 104 and back-end 106 are provisioned in the same computing device, processing circuitry 402, memory circuitry 404, and communication circuitry 406 may be substantially same as processing circuitry 202, memory 204, and communication circuitry 220, respectively.

Memory 404 may be provisioned with a message module 904, a location identifier 906, learning module 142 (and/or learning module 122), knowledge base 144 and inference engine 146, all of which comprise instructions for performing specific operations by processing circuitry 402. In various embodiments, location identifier 906 in reply tool 136 may identify a location where message 228 originated. In one example, the location may be identified by an Internet Protocol (IP) address of message 228. In another example, the location may be identified by location tags of message 228, such as from social media posts in which the location is tagged. Any suitable method to identify the location may be used by location identifier 906 within the broad scope of the embodiments. Inference engine 146 may determine, using one or more machine learning models in learning module 142 (or learning module 122), location-specific information relevant to message 228. The one or more machine learning models may use knowledge base 144 and the location identified by location identifier 906 to derive the location-specific information. Message module 904 may generate reply message 902 including the location-specific information and display reply message 902 in user interface 209 over appropriate channel 110.

FIG. 9B is a simplified flow diagram showing example operations 950 associated with reply tool 136 according to some embodiments of the present disclosure. At 952, the location where message 228 originated may be identified by location identifier 906 in chatbot 102, as described in reference to FIG. 9A above. At 956, inference engine 146 may determine, using one or more machine learning models in learning module 142 (or learning module 122), location-specific information relevant to message 228 based on information in knowledge base 144 and the location identified at operation 952. At 956, message module 904 may generate reply message 902 including the location-specific information. At 958, chatbot 102 may display reply message 902 in user interface 209 over appropriate channel 110.

Although various operations are illustrated in FIG. 9B once each, the operations may be repeated as often as desired, for example, when multiple customers 230 interact concurrently with chatbot 102. In such scenarios, chatbot 102 may generate different responses 236 to such multiple messages 228 concurrently, and automatically perform the recommended actions corresponding to responses 236 without human intervention. For example, customer 230a may request information about a service and another customer 230b may be inquiring about sales; reply tool 136 may appropriately automatically generate separate reply message 902 for customers 230a and 230b without any human intervention.

Note that in FIG. 2 to FIG. 9B, various components are described as part of specific tools, for example, location identifier 906 is described as part of reply tool 136 in FIG. 9A. However, this is merely for example purposes and is not to be construed as a limitation. In various implementations, the components as described may be shared between tools as appropriate. For example, location identifier 906 described in FIG. 9A may be used by forms tool 134 to automatically fill in location-specific fields in forms 808. In another example, question- and answer-module 702 as described in FIG. 7A may share code, algorithms, etc. with query module 804. Various other combinations are encompassed within the broad scope of the embodiments herein. Further, although not explicitly described, any interaction with an application external to chatbot 102 may be through appropriate interfaces, such as AI API interface 114 for interacting with AI engine 112. Thus, for example, where operations are described as using learning module 122, it is to be understood that the interaction with learning module 122 is through AI API interface 114.

Further, a number of components are illustrated in the figures as included in chatbot 102, but any one or more of these components may be omitted or duplicated, as suitable for the particular implementation. Additionally, in various embodiments, chatbot 102 may not include one or more of the components illustrated in the figures, but chatbot 102 may include interface circuitry for coupling to the one or more components. For example, chatbot 102 may not be integrated with display device 208, but may include display device interface circuitry (e.g., a connector and driver circuitry) to which display device 208 may be coupled. In some embodiments, chatbot 102 may be provisioned in a computing device that may include peripheral components, such as keyboard, mouse, audio input/output devices, bar code reader, a Quick Response (QR) code reader, sensors, radio frequency identification (RFID) reader, etc. as desired and based on particular needs.

FIG. 10 is a simplified block diagram of system 100 according to some embodiments of the present disclosure. Chatbot 102 may be provisioned over a cloud network 1000 using one or more computing devices 1002. Cloud network 1000 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other communication service provider (CSP) network), a hybrid cloud, a multi-cloud, and so forth. In some embodiments, front-end 104 may be provisioned in computing device 1002a, back-end 106 may be provisioned in computing device 1002b, and AI engine 112 may be provisioned in computing device 1002c. In some embodiments, chatbot 102 may include orchestration platform capabilities, such as coordinating and managing multiple different software applications provisioned in various computing devices 1002 across cloud network 1000. For example, some or all of various tools 126-136 in back-end 106 may be provisioned in separate computing devices 1002 accessible over cloud network 1000, and an orchestration tool provisioned in chatbot 102 (e.g., in back-end 106) may coordinate their activities suitably to perform the various operations as described in the previous figures. In some such embodiments, the orchestration tool may facilitate managing and monitoring tools 126-136 centrally (e.g., in computing device 1002b), provisioning workload and storage capacities suitably, and also deploying dependencies among components of chatbot 102 over cloud network 1000. Channels 110 may operate through cloud network 1000 to effectuate communication with chatbot 102. In some embodiments, computing devices 1002a and 1002b may be separate; in some other embodiments, computing devices 1002a and 1002b may be the same.

In various embodiments, computing devices 1002 may have any desired form factor, such as a handheld or mobile computing device (e.g., a cell phone, a smart phone, a mobile Internet device, a tablet computer, a laptop computer, a netbook computer, an ultra-book computer, a PDA, an ultramobile personal computer, etc.), a desktop computing device, a server or other networked computing component, a set-top box, an entertainment control unit, a vehicle control unit, or a wearable computing device. In some embodiments, computing device 1002 may be any other electronic device that processes data.

FIG. 11 is a simplified diagram of an example GUI 210A in system 100 according to some embodiments of the present disclosure. System 100 may include one or more types of user interfaces 209 such as GUI 210. An example GUI 210a comprises a configuration user interface, which may be used to configure chatbot 102, for example, by user 124 who may be a representative (e.g., employee) of business 232. Appropriate GUIs 210 for other functions may also be provided in chatbot 102 as desired and based on particular needs.

In example GUI 210a, a first section 1100 may be provided for adding preferences, for example, as to modes of operation and supported channels 110. Other preferences (e.g., language, tone, etc.) may also be included within the broad scope of the embodiments. Such other preferences are not shown merely for ease of illustration and not as a limitation. In various embodiments, chatbot 102 may have two different modes of operation: mode 1102a and mode 1102b. Mode 1102a is a suggestive mode, wherein chatbot 102 merely recommends or suggests appropriate responses 236 but does not automatically perform any recommended action. In mode 1102b, called “auto-pilot” mode in example GUI 210a, chatbot 102 may automatically initiate various tools in back-end 106 as described in reference to the previous figures. First section 1100 may provide a means for user 124 interacting with example GUI 210a to select one of modes 1102a or 1102b. In example GUI 210a shown, radio buttons 1103 are used. Other interactive user elements may be provided instead without departing from the scope of the embodiments.

In some embodiments, first section 1100 may display supported channels 110. In example GUI 210a, the supported channels are “SMS”, “GMB”, “Faceb--”, “Instag-” and “Email”. Each selection is presented as a box with an option to delete it or unselect it. Various other means of selecting or displaying supported channels 110 may be included in GUI 210 within the broad scope of the embodiments disclosed herein.

A second section 1104 may provide for configuring various tools 126-136 described in reference to FIG. 1. For example, the configurations may be made using suitable tabbed pages 1106a and 1106b in example GUI 210a. Tabbed page 1106a may allow configuration of booking tool 130. Tabbed page 1106b may allow configuration of payment tool 126. Other tabbed pages (not shown for ease of illustration) may also be provided suitably. In the example tabbed page 1106A, various options of booking tool 130, for example, calendars, conversation flows, customized bot responses, etc. may be configured. For example, a drop-down menu option may be provided to select a particular calendar (e.g., Calendar A). Each calendar may be different from the others based on particular settings. For example, example GUI 210a may be used by a dentist office, and Calendar A may be the calendar for a particular dentist A. Other dentists B-E may have respective calendars B-E, which may be selected using the drop-down menu.

In some embodiments, questions to ask customer 230 may be configured in tabbed page 1106a. The questions may be relevant to the selected calendar, for example. In another example, the questions may be relevant to branching to another tool 126-136. Example questions may be added using an “Add” button 1108, and existing questions edited using an edit button 1110. A text entry box 1112a may be provided for user 124 to enter text as necessary. In example GUI 210a, text entry box 1112a is provided for user 124 to enter a default answer that chatbot 102 may display when it does not have enough information to provide.

An option may be provided in tabbed page 1106a to customize responses 236 of chatbot 102. The information provided in this option may be added to knowledge base 144 in some embodiments. As with the conversation flow section, new questions may be added, and existing questions edited using appropriate buttons. Text entry box 1112b may be provided for user 124 to enter configuration information. In some embodiments, user element 1114 may be provided to expand a space to display additional elements. For example, user element 1114 may be a “plus” sign, which when clicked, displays another text entry box 1112c (not shown). Likewise, clicking a “minus” sign may remove the additional element from display. Various such user interaction flows may be configured in GUI 210 within the broad scope of the embodiments.

Note that although only one example tabbed page 1106a is shown, other tabbed pages 1106b, for example, may have other options relevant to the functionalities therein. For example, the conversation flow in tabbed page 1106b for configuring payment tool 126 may include picking different payment options, or questions related to payment processing, such as bank information, or credit card information. The various options presented in example GUI 210a are merely examples and are not to be construed as limitations. Any suitable format and content of user interface 209 may be included in system 100 within the broad scope of the embodiments.

Note that although certain user elements are shown in the figures, such is merely for example purposes and is not to be construed as a limitation. Any of such user elements may be omitted in certain embodiments, and others may be added based on particular needs as desired. All such variations and combinations are included in the broad scope of the embodiments disclosed herein.

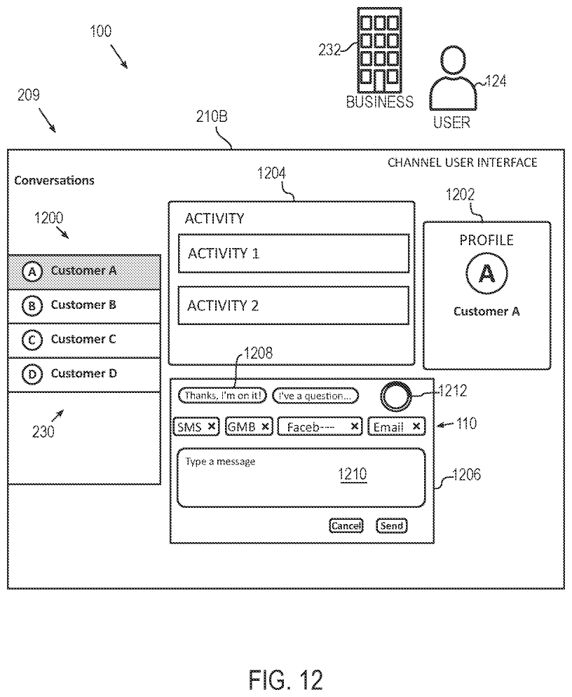

FIG. 12 is a simplified diagram of another example GUI 210b in system 100 according to some embodiments of the present disclosure. Example GUI 210b may be a channel user interface, visible to user 124 at business 232, interacting with customer 230 (e.g., customer A). In example GUI 210b, a first section 1200 may be provided to list conversations with multiple customers 230. For example, a list may be displayed showing customers A, B, C, D, etc. who are concurrently having conversations with user 124, or who have had conversations with user 124 in the past. One in the list may be highlighted or selected to indicate that a conversation is ongoing with the highlighted/selected party, and the selected customer's information may be displayed adjacent to first section 1200. In the example shown, customer A is selected.

A second section 1202 may display profile information of customer A, including name, contact information, etc. relevant to the conversation. A third section 1204 may display past actions with customer A. For example, activity 1 may be payment of an invoice; activity 2 may be scheduling an appointment, etc. A fourth section 1206 may display a chat window of chatbot 102. In example GUI 210b shown, mode 1102a, i.e., suggestive mode, is displayed. Accordingly, suggestions 1208 for response 236 may be provided in fourth section 1206. Clicking on (or otherwise selecting) one of suggestions 1208 may cause it to be displayed in chat window 1210 without any need for user 124 to manually type in the words. A timer 1212 may be displayed in fourth section 1206. Timer 1212 may indicate the amount of time left before the mode of operation of chatbot 102 switches from mode 1102a, i.e., suggestive, to 1102b, i.e., auto-pilot in some embodiments. In another embodiments, timer 1212 may indicate the amount of time left before chatbot 102 goes to sleep due to inactivity. In mode 1102b, chatbot 102 may select an appropriate message, auto-fill chat window 1210 with the selected message and send it over appropriate channel 110. In various embodiments supported channels 110 may also be displayed in fourth section 1206.

Note that although certain user elements are shown in the figures, such is merely for example purposes and is not to be construed as a limitation. Any of such user elements may be omitted in certain embodiments, and others may be added based on particular needs as desired. All such variations and combinations are included in the broad scope of the embodiments disclosed herein.

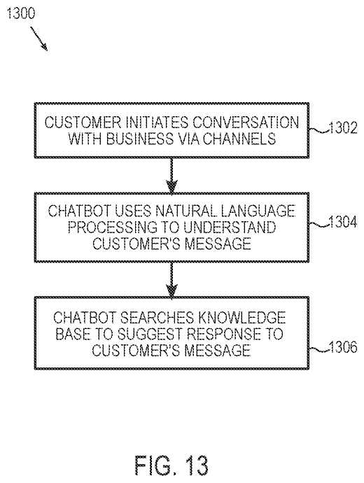

FIG. 13 is a simplified flow diagram showing example operations 1300 for customized chatbot 102 according to some embodiments of the present disclosure. Operations 1300 may be performed when chatbot 102 is operating in mode 1102a, i.e., suggestive mode. At 1302, customer 230 may initiate a conversation with business 232 via one of channels 110, for example, by sending message 238. At 1304, chatbot 102 uses NLP to understand meaning 302 of message 238. At 1306, chatbot 102 may search knowledge base 144 to suggest response 236 to message 228 from customer 230 in view of identified meaning 302.

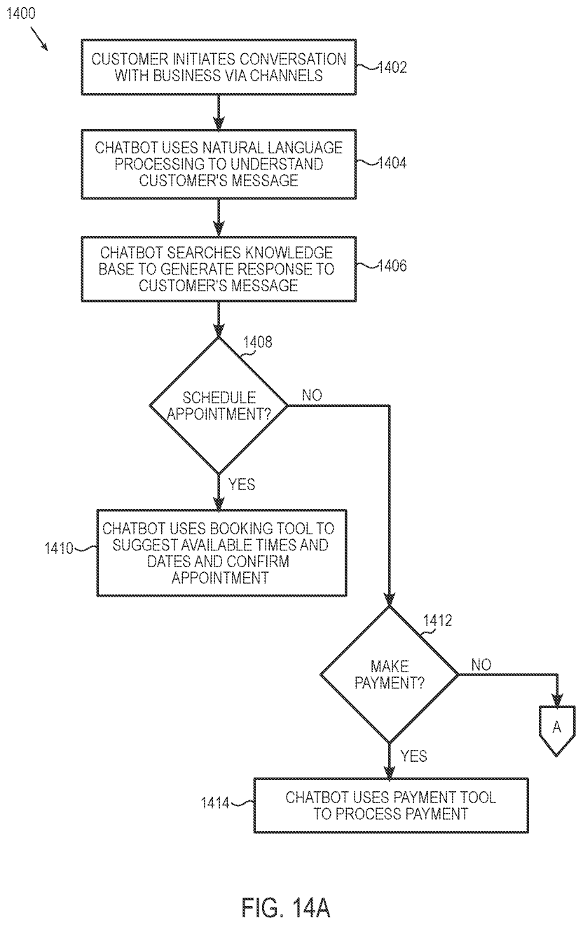

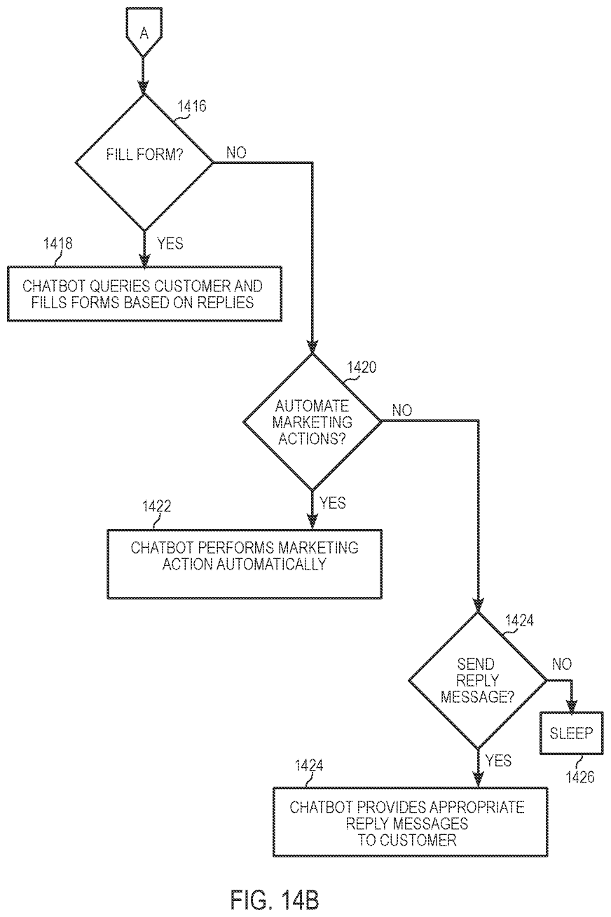

FIGS. 14A and 14B are simplified flow diagrams showing other example operations 1400 for customized chatbot 102 according to some embodiments of the present disclosure. Operations 1400 may be performed when chatbot 102 is operating in mode 1102b, i.e., auto-pilot mode. In FIG. 14A, at 1402, customer 230 may initiate a conversation with business 232 via one of channels 110, for example, by sending message 238. At 1404, chatbot 102 uses NLP to understand meaning 302 of message 238. At 1406, chatbot 102 may search knowledge base 144 to generate response 236 to message 228 from customer 230 in view of identified meaning 302. Response 236 may include a recommended action. At 1408, a determination may be made whether the recommended action is to schedule an appointment. If yes, at 1410, chatbot 102 may use booking tool 130 to suggest available dates and times and confirm an appointment. If the recommended action is not to schedule an appointment, a determination may be made at 1412 whether a payment is to be made. If yes, at 1414, chatbot 102 may use payment tool 126 to process the payment. If the recommended action is not to make a payment, the operations may step to 1416 in FIG. 14B.

In FIG. 14B, at 1416, a determination may be made whether to fill form 808. If yes, at 1418, chatbot 102 may use forms tool 134 to ask customer 230 queries 806 and send filled form 812 based on query responses 810. If the recommended action is not filling any form, a determination may be made at 1420 whether to automate any marketing action. If yes, at 1422, chatbot 102 may use marketing automation tool 128 to perform marketing action 504 automatically, for example, by sending personal and relevant marketing messages to customer 230. If the recommended action is not to automate any marketing action, a determination may be made at 1424 whether to send reply message 902. If yes, at 1424, chatbot 102 may provide appropriate reply message 902 to customer 230. If no further action is to be taken, chatbot 102 may go to sleep at 1426.

Although FIGS. 14A and 14B illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to FIGS. 14A-14B may be modified in accordance with the present disclosure to operate chatbot 102 suitably based on particular needs. For example, chatbot 102 may automate marketing actions 504 according to query responses 810 received for filling form 808. Although various operations are illustrated in FIGS. 14A-14B once each, the operations may be repeated as often as desired, for example, for multiple customers 230 interacting concurrently with chatbot 102.

### SELECT EXAMPLES

Example 1 provides a method for operating a customized chatbot using artificial intelligence, the method performed by a server in a cloud network, the method comprising: receiving a message via one of a plurality of channels, each channel being communicatively coupled to one or more applications executing in one or more computing devices separate from the server; identifying a meaning of the message using at least one natural language processing algorithm; retrieving information from a knowledge base coupled to the server, in which the information is relevant to the identified meaning of the message, the information further comprises attributes of a plurality of intents, and the plurality of intents comprises at least (i) payment processing and (ii) automated marketing actions; generating, using at least one machine learning model, a response recommending an action to fulfill one in the plurality of intents, in which the at least one machine learning model uses the information retrieved from the knowledge base to derive the recommended action, and the recommended action is more relevant to the identified meaning of the message than other actions to fulfill any intent in the plurality of intents; displaying the response in a user interface; and automatically performing the recommended action.
Example 2 provides the method of example 1, in which the plurality of intents further comprises: replying to the message; appointment booking; form filling; data storage; and troubleshooting.
Example 3 provides the method of any one of examples 1-2, in which the user interface comprises at least one of: graphical user interface (GUI), command line interface (CLI), natural language interface (NLI), menu-driven Interface and form-based interface.
Example 4 provides the method of any one of examples 1-3, in which the message comprises a transaction between a customer and a business, and the knowledge base comprises data from past transactions between the customer and the business.
Example 5 provides the method of any one of examples 1-4, in which the message comprises a transaction between a customer and a business, and the knowledge base comprises past data from other transactions conducted by the business.
Example 6 provides the method of any one of examples 1-5, in which the recommended action is to process a payment, and performing the recommended action comprises: recommending, using one or more machine learning models, one in a plurality of payment types for processing the payment, in which the one or more machine learning models uses the knowledge base to derive the recommended one in the plurality of payment types; displaying a payment form in the user interface, the payment form being relevant to the recommended one in the plurality of payment types; receiving data through the payment form; and processing the payment using the data.
Example 7 provides the method of any one of examples 1-5, in which the recommended action is to execute automated marketing actions, and performing the recommended action comprises: recommending, using one or more machine learning models, a plurality of marketing actions, in which the plurality of marketing actions comprises at least one of an email campaign and a social media post campaign, the knowledge base includes customer preferences for the plurality of marketing actions, and the one or more machine learning models uses the knowledge base to derive the recommended plurality of marketing actions; retrieving customer data from the knowledge base; generating a schedule for the recommended plurality of marketing actions based on the customer data; and automatically performing the recommended plurality of marketing actions according to the generated schedule.
Example 8 provides the method of any one of examples 1-5, in which the recommended action is booking an appointment, and performing the recommended action comprises: looking up at least one calendar, the calendar comprising a plurality of available dates and times for an appointment; recommending, using one or more machine learning models, a date and time in the plurality of available dates and times for the appointment, in which the one or more machine learning models uses the knowledge base to derive the recommended date and time; and sending a calendar link for the appointment with the recommended date and time.
Example 9 provides the method of any one of examples 1-5, in which the recommended action is filling a form, and performing the recommended action comprises: generating queries based on fields to be filled in the form; displaying the queries in the user interface; receiving responses to the queries from the user interface; adding the responses to the knowledge base; auto-populating the fields in the form with the responses; and sending the filled form via the one of the plurality of channels.
Example 10 provides the method of any one of examples 1-5, in which the recommended action is troubleshooting one or more errors, and performing the recommended action comprises: generating a series of questions related to the one or more errors; displaying the series of questions in the user interface; receiving answers to the series of questions from the user interface; recommending, using one or more machine learning models, an action to repair the one or more errors, in which the one or more machine learning models use the knowledge base to derive the recommended action to repair the one or more errors; generating an instruction based on the recommended action; and displaying the instruction in the user interface.
Example 11 provides the method of any one of examples 1-5, in which the recommended action is sending a reply message, and performing the recommended action comprises: identifying a location where the message originated; determining, using one or more machine learning models, location-specific information relevant to the message, in which the one or more machine learning models use the knowledge base and the location to derive the location-specific information; generating the reply message including the location-specific information; and displaying the reply message in the user interface.
Example 12. Non-transitory computer-readable tangible media that includes instructions for execution, which when executed by a processor of a computing device in a cloud network, is operable to perform operations comprising: receiving a message via one of a plurality of channels, each channel being communicatively coupled to one or more applications executing in one or more computing devices separate from the computing device in the cloud network; identifying a meaning of the message using at least one natural language processing algorithm; retrieving information from a knowledge base coupled to the computing device in the cloud network, in which the information is relevant to the identified meaning of the message, the information further comprises attributes of a plurality of intents, and the plurality of intents comprises at least (i) processing a payment and (ii) executing automated marketing actions; generating, using at least one machine learning model, a response recommending an action to fulfill one in the plurality of intents, in which the at least one machine learning model uses the information retrieved from the knowledge base to derive the recommended action, and the recommended action is more relevant to the identified meaning of the message than other actions to execute any intent in the plurality of intents; displaying the response in a user interface; and automatically performing the recommended action.
Example 13 provides the non-transitory computer-readable tangible media of example 12, in which the recommended action is to process a payment, and performing the recommended action comprises: recommending, using one or more machine learning models, one in a plurality of payment types for processing the payment, in which the one or more machine learning models uses the knowledge base to derive the recommended one in the plurality of payment types; displaying a payment form in the user interface, the payment form being relevant to the recommended one in the plurality of payment types; receiving data through the payment form; processing the payment using the data; and sending a receipt after successfully processing the payment.
Example 14 provides the non-transitory computer-readable tangible media of example 12, in which the recommended action is to execute automated marketing actions, and performing the recommended action comprises: recommending, using one or more machine learning models, a plurality of marketing actions, in which the plurality of marketing actions comprises at least one of an email campaign and a social media post campaign, the knowledge base includes customer preferences for the plurality of marketing actions, and the one or more machine learning models uses the knowledge base to derive the recommended plurality of marketing actions; retrieving customer data from the knowledge base; generating a schedule for the recommended plurality of marketing actions based on the customer data; and automatically performing the recommended plurality of marketing actions according to the generated schedule.
Example 15 provides the non-transitory computer-readable tangible media of example 12, in which the recommended action is booking an appointment, and performing the recommended action comprises: looking up at least one calendar, the calendar comprising a plurality of available dates and times for an appointment; recommending, using one or more machine learning models, a date and time in the plurality of available dates and times for the appointment, in which the one or more machine learning models uses the knowledge base to derive the recommended date and time; and sending a calendar link for the appointment with the recommended date and time.
Example 16 provides the non-transitory computer-readable tangible media of example 12, in which the recommended action is filling a form, and performing the recommended action comprises: generating queries based on fields to be filled in the form; displaying the queries in the user interface; receiving responses to the queries from the user interface; storing the responses to the queries in a data store; auto-populating the fields in the form with the responses; and sending the filled form via the one of the plurality of channels.
Example 17 provides the non-transitory computer-readable tangible media of example 12, in which the recommended action is troubleshooting one or more errors, and performing the recommended action comprises: generating a series of questions related to the one or more errors; displaying the series of questions in the user interface; receiving answers to the series of questions from the user interface; recommending, using one or more machine learning models, an action to repair the one or more errors, in which the one or more machine learning models use the knowledge base to derive the recommended action to repair the one or more errors; generating an instruction based on the recommended action; and displaying the instruction in the user interface.
Example 18 provides the non-transitory computer-readable tangible media of example 12, in which the recommended action is sending a reply message, and performing the recommended action comprises: identifying a location where the message originated; determining, using one or more machine learning models, location-specific information relevant to the message, in which the one or more machine learning models use the knowledge base and the location to derive the location-specific information; generating the reply message including the location-specific information; and displaying the reply message in the user interface.
Example 19 provides an apparatus, comprising a display device; a communication circuitry; a memory for storing data; and a processing circuitry, in which the processing circuitry executes instructions associated with the data, the processing circuitry is coupled to the display device, the communication circuitry and the memory, and the processing circuitry and the memory cooperate, such that the apparatus is configured for: receiving a message via one of a plurality of channels, each channel being communicatively coupled to one or more applications executing in one or more computing devices separate from the apparatus; identifying a meaning of the message using at least one natural language processing algorithm; retrieving information from a knowledge base stored in the memory, in which the information is relevant to the identified meaning of the message, the information further comprises attributes of a plurality of intents, and the plurality of intents comprises at least (i) processing a payment and (ii) executing automated marketing actions; generating, using at least one machine learning model, a response recommending an action to fulfill one in the plurality of intents, in which the at least one machine learning model uses the information retrieved from the knowledge base to derive the recommended action, and the recommended action is more relevant to the identified meaning of the message than other actions to execute any intent in the plurality of intents; displaying the response in a user interface; and automatically performing the recommended action.
Example 20 provides the apparatus of example 19, in which the recommended action is to process a payment, and performing the recommended action comprises: recommending, using one or more machine learning models, one in a plurality of payment types for processing the payment, in which the one or more machine learning models uses the knowledge base to derive the recommended one in the plurality of payment types; displaying a payment form in the user interface, the payment form being relevant to the recommended one in the plurality of payment types; receiving data through the payment form; processing the payment using the data; and sending a receipt after successfully processing the payment.
Example 21 provides the apparatus of example 19, in which the recommended action is to execute automated marketing actions, and performing the recommended action comprises: recommending, using one or more machine learning models, a plurality of marketing actions, in which the plurality of marketing actions comprises at least one of an email campaign and a social media post campaign, the knowledge base includes customer preferences for the plurality of marketing actions, and the one or more machine learning models uses the knowledge base to derive the recommended plurality of marketing actions; retrieving customer data from the knowledge base; generating a schedule for the recommended plurality of marketing actions based on the customer data; and automatically performing the recommended plurality of marketing actions according to the generated schedule.
Example 22 provides the apparatus of example 19, in which the recommended action is booking an appointment, and performing the recommended action comprises: looking up at least one calendar, the calendar comprising a plurality of available dates and times for an appointment; recommending, using one or more machine learning models, a date and time in the plurality of available dates and times for the appointment, in which the one or more machine learning models uses the knowledge base to derive the recommended date and time; and sending a calendar link for the appointment with the recommended date and time.
Example 23 provides the apparatus of example 19, in which the recommended action is filling a form, and performing the recommended action comprises: generating queries based on fields to be filled in the form; displaying the queries in the user interface; receiving responses to the queries from the user interface; storing the responses to the queries in a data store; auto-populating the fields in the form with the responses; and sending the filled form via the one of the plurality of channels.
Example 24 provides the apparatus of example 19, in which the recommended action is troubleshooting one or more errors, and performing the recommended action comprises: generating a series of questions related to the one or more errors; displaying the series of questions in the user interface; receiving answers to the series of questions from the user interface; recommending, using one or more machine learning models, an action to repair the one or more errors, in which the one or more machine learning models use the knowledge base to derive the recommended action to repair the one or more errors; generating an instruction based on the recommended action; and displaying the instruction in the user interface.
Example 25 provides the apparatus of example 19, in which the recommended action is sending a reply message, and performing the recommended action comprises: identifying a location where the message originated; determining, using one or more machine learning models, location-specific information relevant to the message, in which the one or more machine learning models use the knowledge base and the location to derive the location-specific information; generating the reply message including the location-specific information; and displaying the reply message in the user interface.
Example 26 provides a method for operating a customized chatbot using artificial intelligence, the method performed by a server in a cloud network, the method comprising: receiving messages from different customers via a plurality of channels, each channel being communicatively coupled to one or more applications executing in one or more computing devices separate from the server; identifying respective meanings of each message using at least one natural language processing algorithm; retrieving information from a knowledge base coupled to the server, in which the information is relevant to the respective meanings of the messages, and the information further comprises attributes of a plurality of intents; generating, using at least one machine learning model, a plurality of responses, each response recommending an action to fulfill one in the plurality of intents, in which the at least one machine learning model uses the information retrieved from the knowledge base to derive the recommended actions, and the recommended actions are more relevant to the respective meanings of the corresponding messages than other actions to execute any intent in the plurality of intents; mapping the plurality of responses to the plurality of channels corresponding to the messages; displaying the plurality of responses in respective user interfaces via the corresponding channels according to the mapping; and performing the recommended actions concurrently.
Example 27 provides the method of example 26, in which the messages comprise respective transactions between the different customers and a business, and the knowledge base comprises data from past transactions between the different customers and the business.
Example 28 provides the method of any one of examples 26-27, in which the messages comprise respective transactions between the different customers and a business, and the knowledge base comprises past data from other transactions conducted by the business.
Example 29 provides the method of any one of examples 26-28, in which the plurality of intents comprise sending a reply message; processing a payment; booking an appointment; filling a form; storing data; troubleshooting one or more errors; and executing automated marketing actions.
Example 30 provides the method of example 29, in which attributes of sending a reply message includes one or more contact addresses of a recipient of the reply message and the corresponding channels for sending the reply message, attributes of processing a payment include credit card processing information, electronic funds transfer information, and wire transfer information, attributes of booking an appointment include one or more calendars associated with a sender of the message, attributes of filling a form include one or more fields to be filled in the form, attributes of storing data include one or more formats for data storage, attributes of troubleshooting one or more errors include types of the one or more errors, and attributes of executing automated marketing actions include types of marketing actions and corresponding channels for deploying the marketing actions.
Example 31. Non-transitory computer-readable tangible media that includes instructions for execution, which when executed by a processor of a computing device in a cloud network, is operable to perform operations comprising: receiving messages from different customers via a plurality of channels, each channel being communicatively coupled to one or more applications executing in one or more computing devices separate from the computing device in the cloud network; identifying respective meanings of each message using at least one natural language processing algorithm; retrieving information from a knowledge base coupled to the computing device in the cloud network, in which the information is relevant to the respective meanings of the messages, and the information further comprises attributes of a plurality of intents; generating, using at least one machine learning model, a plurality of responses, each response recommending an action to fulfill one in the plurality of intents, in which the at least one machine learning model uses the information retrieved from the knowledge base to derive the recommended actions, and the recommended actions are more relevant to the respective meanings of the corresponding messages than other actions to execute any intent in the plurality of intents; mapping the plurality of responses to the plurality of channels corresponding to the messages; displaying the plurality of responses in respective user interfaces relevant to the corresponding channels according to the mapping; and performing the recommended actions concurrently.
Example 32 provides the non-transitory computer-readable tangible media of example 31, in which the messages comprise respective transactions between the different customers and a business, and the knowledge base comprises data from past transactions between the different customers and the business.
Example 33 provides the non-transitory computer-readable tangible media of ane one of examples 31-32, in which the messages comprise respective transactions between the different customers and a business, and the knowledge base comprises past data from other transactions conducted by the business.
Example 34 provides the non-transitory computer-readable tangible media of any one of examples 31-33, in which the plurality of intents comprise sending a reply message; processing a payment; booking an appointment; filling a form; storing data; troubleshooting one or more errors; and executing automated marketing actions.
Example 35 provides the non-transitory computer-readable tangible media of example 34, in which attributes of sending a reply message includes one or more contact addresses of a recipient of the reply message and the corresponding channels for sending the reply message, attributes of processing a payment include credit card processing information, electronic funds transfer information, and wire transfer information, attributes of booking an appointment include one or more calendars associated with a sender of the message, attributes of filling a form include one or more fields to be filled in the form, attributes of storing data include one or more formats for data storage, attributes of troubleshooting one or more errors include types of the one or more errors, and attributes of executing automated marketing actions include types of marketing actions and corresponding channels for deploying the marketing actions.
Example 36 provides an apparatus, comprising a display device; a communication circuitry; a memory for storing data; and a processing circuitry, in which the processing circuitry executes instructions associated with the data, the processing circuitry is coupled to the display device, the communication circuitry and the memory, and the processing circuitry and the memory cooperate, such that the apparatus is configured for: receiving messages from different customers via a plurality of channels, each channel being communicatively coupled to one or more applications executing in one or more computing devices separate from the apparatus; identifying respective meanings of each message using at least one natural language processing algorithm; retrieving information from a knowledge base stored in the memory, in which the information is relevant to the respective meanings of the messages, and the information further comprises attributes of a plurality of intents; generating, using at least one machine learning model, a plurality of responses, each response recommending an action to fulfill one in the plurality of intents, in which the at least one machine learning model uses the information retrieved from the knowledge base to derive the recommended actions, and the recommended actions are more relevant to the respective meanings of the corresponding messages than other actions to execute any intent in the plurality of intents; mapping the plurality of responses to the plurality of channels corresponding to the messages; displaying the plurality of responses in respective user interfaces via the corresponding channels according to the mapping; and performing the recommended actions concurrently.
Example 37 provides the apparatus of example 36, in which the messages comprise respective transactions between the different customers and a business, and the knowledge base comprises data from past transactions between the different customers and the business.
Example 38 provides the apparatus of any one of examples 36-37, in which the messages comprise respective transactions between the different customers and a business, and the knowledge base comprises past data from other transactions conducted by the business.
Example 39 provides the apparatus of any one of examples 36-39, in which the plurality of intents comprises sending a reply message; processing a payment; booking an appointment; filling a form; storing data; troubleshooting one or more errors; and executing automated marketing actions.
Example 40 provides the apparatus of example 39, in which attributes of sending a reply message includes one or more contact addresses of a recipient of the reply message and the corresponding channels for sending the reply message, attributes of processing a payment include credit card processing information, electronic funds transfer information, and wire transfer information, attributes of booking an appointment include one or more calendars associated with a sender of the message, attributes of filling a form include one or more fields to be filled in the form, attributes of storing data include one or more formats for data storage, attributes of troubleshooting one or more errors include types of the one or more errors, and attributes of executing automated marketing actions include types of marketing actions and corresponding channels for deploying the marketing actions.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for operating a customized chatbot using artificial intelligence, the method performed by a server in a cloud network, the method comprising:
receiving a message via one of a plurality of channels, each channel being communicatively coupled to one or more applications executing in one or more computing devices separate from the server;
identifying a meaning of the message using at least one natural language processing algorithm;
retrieving information from a knowledge base coupled to the server, wherein:
the information is relevant to the identified meaning of the message,
the information further comprises attributes of a plurality of intents, and
the plurality of intents comprises at least (i) payment processing and (ii) automated marketing actions;
generating, using at least one machine learning model, a response recommending an action to fulfill one in the plurality of intents, wherein:
the at least one machine learning model uses the information retrieved from the knowledge base to derive the recommended action, and
the recommended action is more relevant to the identified meaning of the message than other actions to fulfill any intent in the plurality of intents;
displaying the response in a user interface; and
automatically performing the recommended action.

2. The method of claim 1, wherein the plurality of intents further comprises:
replying to the message;
appointment booking;
form filling;
data storage; and
troubleshooting.

3. The method of claim 1, wherein:
the message comprises a transaction between a customer and a business, and
the knowledge base comprises past data from other transactions conducted by the business.

4. The method of claim 1, wherein the recommended action is to process a payment, and performing the recommended action comprises:
recommending, using one or more machine learning models, one in a plurality of payment types for processing the payment, wherein the one or more machine learning models uses the knowledge base to derive the recommended one in the plurality of payment types;
displaying a payment form in the user interface, the payment form being relevant to the recommended one in the plurality of payment types;
receiving data through the payment form; and
processing the payment using the data.

5. The method of claim 1, wherein the recommended action is to execute automated marketing actions, and performing the recommended action comprises:
recommending, using one or more machine learning models, a plurality of marketing actions, wherein:
the plurality of marketing actions comprises at least one of an email campaign and a social media post campaign,
the knowledge base includes customer preferences for the plurality of marketing actions, and
the one or more machine learning models uses the knowledge base to derive the recommended plurality of marketing actions;
retrieving customer data from the knowledge base;
generating a schedule for the recommended plurality of marketing actions based on the customer data; and
automatically performing the recommended plurality of marketing actions according to the generated schedule.

6. The method of claim 1, wherein:
the recommended action is booking an appointment, and
performing the recommended action comprises:
looking up at least one calendar, the calendar comprising a plurality of available dates and times for an appointment;
recommending, using one or more machine learning models, a date and time in the plurality of available dates and times for the appointment, wherein the one or more machine learning models uses the knowledge base to derive the recommended date and time; and
sending a calendar link for the appointment with the recommended date and time.

7. The method of claim 1, wherein:
the recommended action is filling a form, and
performing the recommended action comprises:
generating queries based on fields to be filled in the form;
displaying the queries in the user interface;
receiving responses to the queries from the user interface;
adding the responses to the knowledge base;
auto-populating the fields in the form with the responses; and
sending the filled form via the one of the plurality of channels.

8. The method of claim 1, wherein:
the recommended action is troubleshooting one or more errors, and
performing the recommended action comprises:
generating a series of questions related to the one or more errors;
displaying the series of questions in the user interface;
receiving answers to the series of questions from the user interface;
recommending, using one or more machine learning models, an action to repair the one or more errors, wherein the one or more machine learning models use the knowledge base to derive the recommended action to repair the one or more errors;
generating an instruction based on the recommended action; and
displaying the instruction in the user interface.

9. Non-transitory computer-readable tangible media that includes instructions for execution, which when executed by a processor of a computing device in a cloud network, is operable to perform operations comprising:
receiving a message via one of a plurality of channels, each channel being communicatively coupled to one or more applications executing in one or more computing devices separate from the computing device in the cloud network;
identifying a meaning of the message using at least one natural language processing algorithm;
retrieving information from a knowledge base coupled to the computing device in the cloud network, wherein:
the information is relevant to the identified meaning of the message,
the information further comprises attributes of a plurality of intents, and
the plurality of intents comprises at least (i) processing a payment and (ii) executing automated marketing actions;
generating, using at least one machine learning model, a response recommending an action to fulfill one in the plurality of intents, wherein:
the at least one machine learning model uses the information retrieved from the knowledge base to derive the recommended action, and
the recommended action is more relevant to the identified meaning of the message than other actions to execute any intent in the plurality of intents;
displaying the response in a user interface; and
automatically performing the recommended action.

10. The non-transitory computer-readable tangible media of claim 9, wherein the recommended action is to process a payment, and performing the recommended action comprises:
recommending, using one or more machine learning models, one in a plurality of payment types for processing the payment, wherein the one or more machine learning models uses the knowledge base to derive the recommended one in the plurality of payment types;
displaying a payment form in the user interface, the payment form being relevant to the recommended one in the plurality of payment types;
receiving data through the payment form;
processing the payment using the data; and
sending a receipt after successfully processing the payment.

11. The non-transitory computer-readable tangible media of claim 9, wherein the recommended action is to execute automated marketing actions, and performing the recommended action comprises:
recommending, using one or more machine learning models, a plurality of marketing actions, wherein:
the plurality of marketing actions comprises at least one of an email campaign and a social media post campaign,
the knowledge base includes customer preferences for the plurality of marketing actions, and
the one or more machine learning models uses the knowledge base to derive the recommended plurality of marketing actions;
retrieving customer data from the knowledge base;
generating a schedule for the recommended plurality of marketing actions based on the customer data; and
automatically performing the recommended plurality of marketing actions according to the generated schedule.

12. The non-transitory computer-readable tangible media of claim 9, wherein:
the recommended action is booking an appointment, and
performing the recommended action comprises:
looking up at least one calendar, the calendar comprising a plurality of available dates and times for an appointment;
recommending, using one or more machine learning models, a date and time in the plurality of available dates and times for the appointment, wherein the one or more machine learning models uses the knowledge base to derive the recommended date and time; and
sending a calendar link for the appointment with the recommended date and time.

13. The non-transitory computer-readable tangible media of claim 9, wherein:
the recommended action is filling a form, and
performing the recommended action comprises:
generating queries based on fields to be filled in the form;
displaying the queries in the user interface;
receiving responses to the queries from the user interface;
storing the responses to the queries in a data store;
auto-populating the fields in the form with the responses; and
sending the filled form via the one of the plurality of channels.

14. The non-transitory computer-readable tangible media of claim 9, wherein:
the recommended action is troubleshooting one or more errors, and
performing the recommended action comprises:
generating a series of questions related to the one or more errors;
displaying the series of questions in the user interface;
receiving answers to the series of questions from the user interface;
recommending, using one or more machine learning models, an action to repair the one or more errors, wherein the one or more machine learning models use the knowledge base to derive the recommended action to repair the one or more errors;
generating an instruction based on the recommended action; and
displaying the instruction in the user interface.

15. An apparatus, comprising:
a display device;
a communication circuitry;
a memory for storing data; and
a processing circuitry, wherein the processing circuitry executes instructions associated with the data, the processing circuitry is coupled to the display device, the communication circuitry and the memory, and the processing circuitry and the memory cooperate, such that the apparatus is configured for:
receiving a message via one of a plurality of channels, each channel being communicatively coupled to one or more applications executing in one or more computing devices separate from the apparatus;
identifying a meaning of the message using at least one natural language processing algorithm;
retrieving information from a knowledge base stored in the memory, wherein:
the information is relevant to the identified meaning of the message,
the information further comprises attributes of a plurality of intents, and
the plurality of intents comprises at least (i) processing a payment and (ii) executing automated marketing actions;
generating, using at least one machine learning model, a response recommending an action to fulfill one in the plurality of intents, wherein:
the at least one machine learning model uses the information retrieved from the knowledge base to derive the recommended action, and
the recommended action is more relevant to the identified meaning of the message than other actions to execute any intent in the plurality of intents;
displaying the response in a user interface; and
automatically performing the recommended action.

16. The apparatus of claim 15, wherein the recommended action is to process a payment, and performing the recommended action comprises:
recommending, using one or more machine learning models, one in a plurality of payment types for processing the payment, wherein the one or more machine learning models uses the knowledge base to derive the recommended one in the plurality of payment types;
displaying a payment form in the user interface, the payment form being relevant to the recommended one in the plurality of payment types;
receiving data through the payment form;
processing the payment using the data; and
sending a receipt after successfully processing the payment.

17. The apparatus of claim 15, wherein the recommended action is to execute automated marketing actions, and performing the recommended action comprises:
recommending, using one or more machine learning models, a plurality of marketing actions, wherein:
the plurality of marketing actions comprises at least one of an email campaign and a social media post campaign,
the knowledge base includes customer preferences for the plurality of marketing actions, and
the one or more machine learning models uses the knowledge base to derive the recommended plurality of marketing actions;
retrieving customer data from the knowledge base;
generating a schedule for the recommended plurality of marketing actions based on the customer data; and
automatically performing the recommended plurality of marketing actions according to the generated schedule.

18. The apparatus of claim 15, wherein:
the recommended action is booking an appointment, and
performing the recommended action comprises:
looking up at least one calendar, the calendar comprising a plurality of available dates and times for an appointment;
recommending, using one or more machine learning models, a date and time in the plurality of available dates and times for the appointment, wherein the one or more machine learning models uses the knowledge base to derive the recommended date and time; and
sending a calendar link for the appointment with the recommended date and time.

19. The apparatus of claim 15, wherein:
the recommended action is filling a form, and
performing the recommended action comprises:
generating queries based on fields to be filled in the form;
displaying the queries in the user interface;
receiving responses to the queries from the user interface;
storing the responses to the queries in a data store;
auto-populating the fields in the form with the responses; and
sending the filled form via the one of the plurality of channels.

20. The apparatus of claim 15, wherein:
the recommended action is troubleshooting one or more errors, and
performing the recommended action comprises:
generating a series of questions related to the one or more errors;
displaying the series of questions in the user interface;
receiving answers to the series of questions from the user interface;
recommending, using one or more machine learning models, an action to repair the one or more errors, wherein the one or more machine learning models use the knowledge base to derive the recommended action to repair the one or more errors;
generating an instruction based on the recommended action; and
displaying the instruction in the user interface.
